(19) United States
(12) Patent Application Publication
(10) Pub. No.: US 2026/0121799 A1
(43) Pub. Date: Apr. 30, 2026

(54) COMMUNICATION APPARATUS AND COMMUNICATION METHOD FOR INFORMATION CONTAINER

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP)

(21) Appl. No.: 19/116,187

(22) PCT Filed: Sep. 18, 2023
(86) PCT No.: PCT/SG2023/050632

§ 371 Date: Mar. 27, 2025

(30) Foreign Application Priority Data
Sep. 30, 2022 (SG) 10202251232E

(51) Int. Cl. H04L 1/00; H04L 1/1809; H04L 47/36

(52) U.S. Cl. CPC H04L 1/0083; H04L 1/1809; H04L 47/365

(57) ABSTRACT

Communication devices and methods for information container are provided. One exemplary embodiment provides a communication apparatus comprising: circuitry, which in operation, generates an information container that is larger than 255 octets; and a transmitter, which in operation, transmits a frame comprising the information container.

### TECHNICAL FIELD

The present disclosure generally relates to communication methods and apparatuses, and more particularly relates to methods and apparatuses for information container.

### BACKGROUND

Elements, as used in IEEE 802.11 family of standards, provide a generic container to carry variable length information. Subelements are very similar, except that subelement IDs are only defined within the context of a frame or an element. TLV (type/length/value) are also similar to elements and are used in IEEE 802.11 and other standards for similar purposes. A STA may transmit information that is too large to fit in a single element (e.g., >254 octets) by fragmenting the element into a series of elements consisting of the element that the information does not fit, immediately followed by one or more Fragment elements. IEEE 802.11be extends the element fragmentation procedure for subelements of a Multi-Link element. As of D0.2, IEEE 802.11bf uses elements to carry the sensing measurement reports. IEEE 802.11bf has also defined element segmentation method for DMG Sensing Report for the same purpose. Segmented feedback is also used for IEEE 802.11n, IEEE 802.11ac, IEEE 802.11ax and IEEE 802.11be sounding procedures when the compressed feedback frame exceeds 11454 octets.

However, there is still limited discussion on communication apparatuses and methods for information containers that is suitable to carry larger amount of date (e.g., >254 octets).

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for information container.

According to an aspect of the present disclosure, there is provided a communication apparatus comprising: circuitry, which in operation, generates an information container that is larger than 255 octets; and a transmitter, which in operation, transmits a frame comprising the information container.

According to another aspect of the present disclosure, there is provided a communication apparatus comprising: a receiver, which in operation, receives a frame comprising an information container, the information container comprising data that is larger than 255 octets; and circuitry, which in operation, extracts the data from the information container.

According to another aspect of the present disclosure, there is provided a communication method comprising: generating an information container that is larger than 255 octets; and transmitting a frame comprising the information container.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an example illustration of element fragmentation with Element Identifier (ID) Extension.

FIG. 2A depicts an example illustration of an Element format.

FIG. 2B depicts an example illustration of a Subelement format.

FIG. 3 depicts an example illustration of a Jumbo Element according to various embodiments of the present disclosure.

FIG. 4A depicts a scenario in which a Jumbo element may be utilized.

FIG. 4B depicts another scenario in which a Jumbo element may be utilized.

FIG. 5 shows a flowchart illustrating a transmission flow for Jumbo elements according to various embodiments of the present disclosure.

FIG. 6 depicts an illustration of a Jumbo Element without fragmentation according to an embodiment of the present disclosure.

FIG. 7 depicts another illustration of a Jumbo Element without fragmentation according to an embodiment of the present disclosure.

FIG. 8 depicts an illustration of a Jumbo Element with legacy fragmentation according to an embodiment of the present disclosure.

FIG. 9 depicts an illustration of a Jumbo Element with jumbo fragmentation according to an embodiment of the present disclosure.

FIG. 10 depicts an illustration of a Jumbo Element with mixed fragmentation according to an embodiment of the present disclosure.

FIG. 11 depicts an illustration of exemplary fragments of the Jumbo Element in FIG. 10 according to an embodiment of the present disclosure.

FIG. 12 depicts an illustration of exemplary Jumbo Elements used for carrying Sensing Measurement Report according to an embodiment of the present disclosure.

FIG. 13 depicts an illustration of a Jumbo Subelement according to an embodiment of the present disclosure.

FIG. 14 shows a flowchart illustrating a process for Jumbo Subelements according to various embodiments of the present disclosure.

FIG. 15 depicts an illustration of a Jumbo Subelement without fragmentation according to an embodiment of the present disclosure.

FIG. 16 depicts another illustration of a Jumbo Subelement without fragmentation according to an embodiment of the present disclosure.

FIG. 17 depicts an illustration of a Jumbo Subelement with legacy fragmentation according to an embodiment of the present disclosure.

FIG. 18 shows a flowchart illustrating a transmission flow for Jumbo Elements carrying Jumbo Subelements according to various embodiments of the present disclosure.

FIG. 19 depicts an illustration of a Jumbo Element carrying Jumbo Subelements according to an embodiment of the present disclosure.

FIG. 20 depicts an illustration of fragments of a Jumbo Element carrying Jumbo Subelements according to an embodiment of the present disclosure.

FIG. 21 depicts another illustration of a Jumbo Element carrying Jumbo Subelements according to an embodiment of the present disclosure.

FIG. 22 depicts another illustration of fragments of a Jumbo Element carrying Jumbo Subelements according to an embodiment of the present disclosure.

FIG. 23A depicts an example illustration of a Jumbo Fragment Retransmission Poll frame according to an embodiment of the present disclosure.

FIG. 23B depicts an example illustration of retransmission using a Jumbo Fragment Retransmission Poll frame according to an embodiment of the present disclosure

FIG. 24 depicts an alternative format of a Jumbo Element according to an embodiment of the present disclosure.

FIG. 25 depicts an alternative format of a Jumbo Element with Fragmentation Mode 0 or 2 according to an embodiment of the present disclosure.

FIG. 26 depicts an alternative format of a Jumbo Element with Fragmentation Mode 1 or 3 according to an embodiment of the present disclosure.

FIG. 27 depicts a variation of a Jumbo Element according to an embodiment of the present disclosure.

FIG. 28 shows a flowchart illustrating a transmission flow for a Jumbo Element variant according to an embodiment of the present disclosure.

FIG. 29 depicts an example Jumbo Element variant without a control field according to an embodiment of the present disclosure.

FIG. 30 depicts an example Jumbo Element variant without fragmentation according to an embodiment of the present disclosure.

FIG. 31 depicts an example Jumbo Element variant with legacy fragmentation according to an embodiment of the present disclosure.

FIG. 32 depicts an example Jumbo Element variant with jumbo fragmentation according to an embodiment of the present disclosure.

FIG. 33 depicts an example Jumbo Element variant with mixed fragmentation according to an embodiment of the present disclosure.

FIG. 34 depicts fragments of the example Jumbo Element variant in FIG. 33 according to an embodiment of the present disclosure.

FIG. 35 depicts a variation of a Jumbo Subelement according to an embodiment of the present disclosure.

FIG. 36 depicts an example Jumbo Subelement variant without a control field according to an embodiment of the present disclosure.

FIG. 37 depicts a Jumbo TLV (type/length/value) according to an embodiment of the present disclosure.

FIG. 38 depicts a simplified format of a Jumbo Element according to an embodiment of the present disclosure.

FIG. 39 depicts a simplified format of a Jumbo subelement according to an embodiment of the present disclosure.

FIG. 40 depicts a simplified format of a Jumbo TLV according to an embodiment of the present disclosure.

FIG. 41 shows a flowchart illustrating a transmission flow for a Jumbo Element variant according to an embodiment of the present disclosure

FIG. 42 depicts an example configuration of a station (STA) suitable for sensing and communication in accordance with various embodiments of the present disclosure.

FIG. 43 shows a flow diagram illustrating a method for information container according to various embodiments of the present disclosure.

FIG. 44 shows a schematic, partially sectioned view of a STA that can be implemented for processing an information container in accordance with various embodiments of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. There is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for processing, transmission and reception of an information container, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node”are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

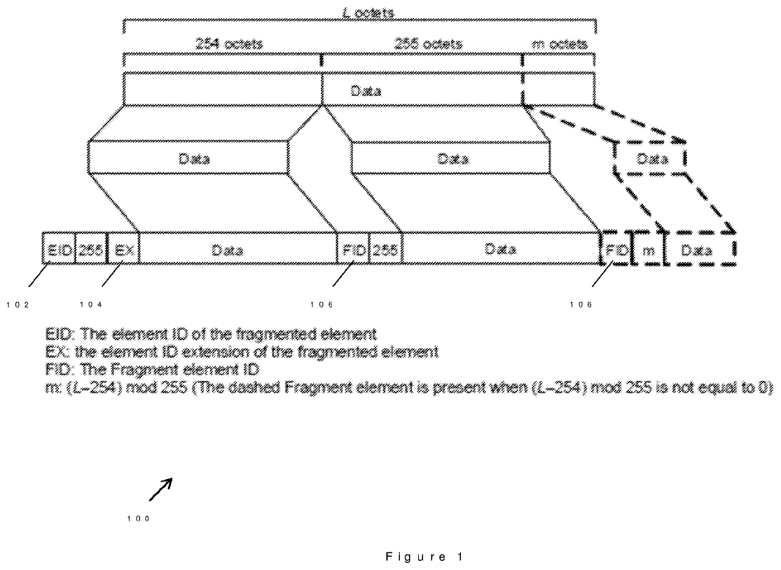

A STA may transmit information that is too large to fit in a single element (e.g., >254 octets) by fragmenting the element into a series of elements consisting of the element that the information does not fit, immediately followed by one or more Fragment elements. All the information for a fragmented element shall be in the same media access control (MAC) Management Protocol Data Unit (MMPDU). FIG. 1 depicts an example illustration 100 of element fragmentation with Element Identifier (ID) Extension, in which Element ID (EID) field 102 indicates the element ID of the fragmented element, Element ID Extension (EX)field 104 is the element ID extension of the fragmented element, and Fragment Element ID (FID) field 106 indicates the fragment element ID. The information to be fragmented is divided into M+N portions. For an element without an Element ID Extension field, L is the size of the information in octets, M is floor(L/255), where floor(x) represents the maximum integer that does not exceed the value x, and N is equal to 1 if L mod 255>0 and equal to 0 if otherwise. For an element with an Element ID Extension field (e.g., EX field 104), L is the size of the information in octets, M is floor((L+1)/255), and N is equal to 1 if (L−254) mod 255>0 and equal to 0 if otherwise.

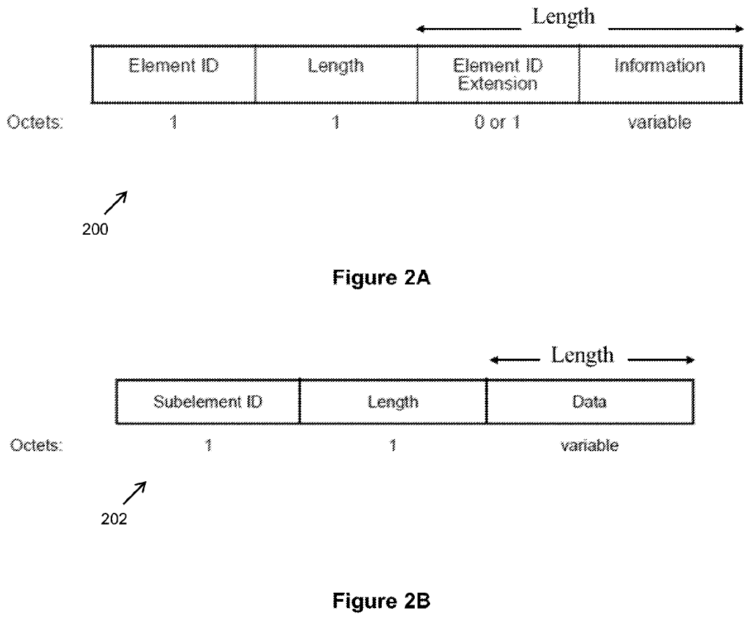

The current element formats (e.g., see element format 200 of FIG. 2A) and subelement formats (e.g., see element format 202 of FIG. 2B) are not suitable to carry large amount of data (>254 octets) since fragmentation causes large overhead. As such, it is desirable to design a unified container for information regardless of size of data (e.g., referred to herein interchangeably as an information container) while being backward compatible (legacy devices can parse). In the present disclosure, new variants of element/subelement/TLV are proposed as information containers for information of variable size (including extended size). The element/subelement/TLV may carry signaling to indicate the method used to fragment the element/subelement/TLV, to indicate the extended size of information carried, and/or to track the fragments of the element/subelement/TLV.

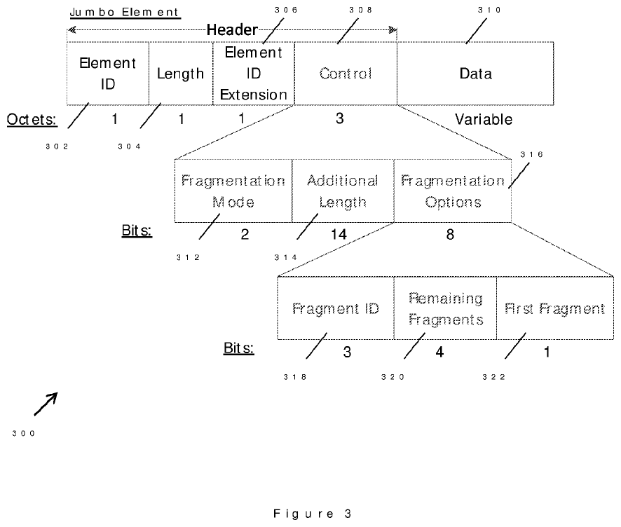

A new variant of elements called Jumbo elements (e.g., Jumbo Element 300 of FIG. 3) may be used as a unified container for information regardless of size of data (e.g., an information container). Meaning of Element ID field 302, Length field 304 and Element ID Extension field 306 may be same as in the baseline standards. One or more values of the Element ID Extension field 306 may uniquely identify Jumbo elements (e.g., values of 96, 97 identify two different Jumbo elements; 96 identifying a Jumbo element used to carry Sensing Measurement Report while 97 identifying a Jumbo element used to carry a extended Multi-Link element). Additional information required to parse the Jumbo element may be carried in Control field 308 that is present immediately prior to Data field 310. Fragmentation mode field 312 may indicate a value based on fragmentation mode used, for example ‘0’ for no fragmentation, ‘1’ for legacy fragmentation, ‘2’ for jumbo fragmentation and ‘3’ for mixed fragmentation. Additional Length field 314 may indicate the number of octets carried in the data field 310. In fragmentation modes 2 or 3 (jumbo fragmentation or mixed fragmentation), the Fragmentation Options field 316 may comprise a Fragment ID field 318 (for uniquely identifying a Jumbo element that is split into multiple fragments and remains the same for all fragments of the same Jumbo element), a Remaining Fragments field 320 (for indicating the number of remaining fragments of a Jumbo element, for example setting to 0 for the last fragment, or setting to a value between 1 and 15 for a fragment that is not the last fragment), and a First Fragment field 322 (set to 1 for indicating first fragment, or set to 0 if not the first fragment). Fragmentation Options field 316 is reserved in fragmentation modes other than 2 or 3 (jumbo fragmentation or mixed fragmentation).

The Element ID field 302, Length field 304, Element ID Extension field 306 and the Control field 308 are considered part of the Header of the Jumbo element 300. 14 bits of Additional Length field 314 can signal Data field length of up to 16,383 octets.

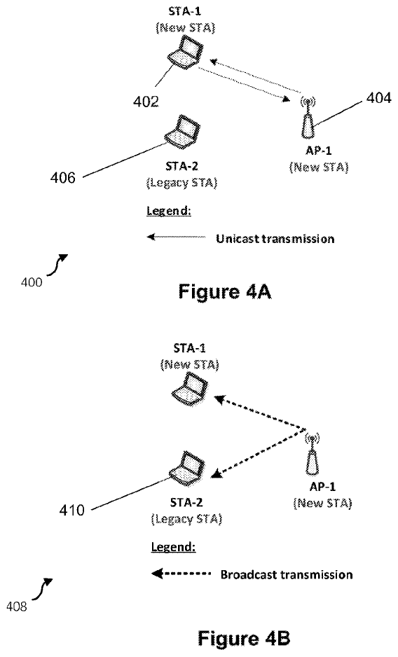

In the present disclosure, Legacy STAs refers to STAs that do not understand the Jumbo element format, while New STAs refer to STAs that understand the format. There may be two scenarios in which the Jumbo elements are used. In a first scenario referring to illustration 400 of FIG. 4A, Legacy STA 406 is not expected to parse the element (e.g., the element is only carried in unicast frames transmitted between New STAs 402 and 404 that understand the Jumbo element format). In a second scenario referring to illustration 408 of FIG. 4B, Legacy STA 410 is expected to parse the element (e.g., the element is carried in broadcast frames that may also be received by legacy STAs). Legacy STAs that are expected to parse the element should be able to correctly discard the element.

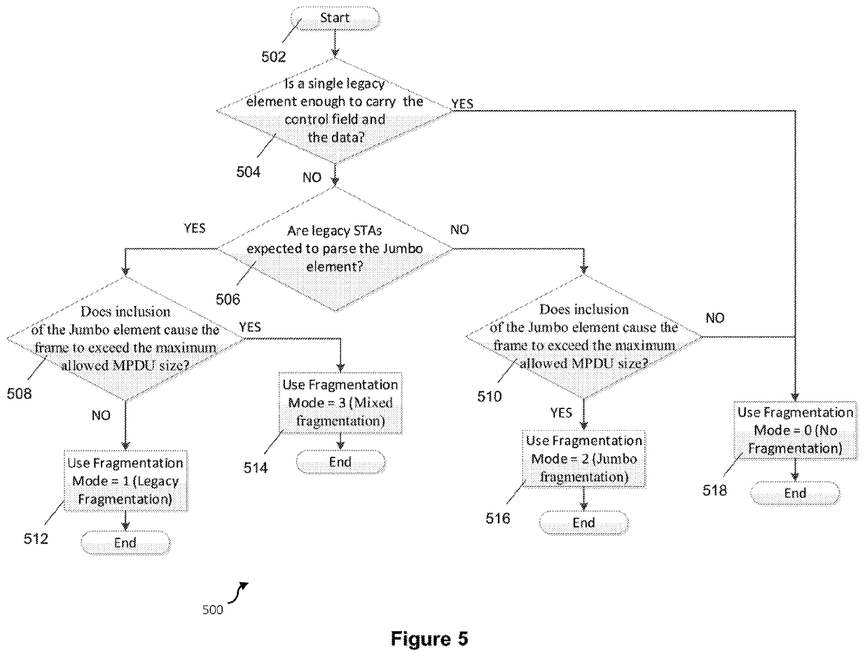

FIG. 5 shows a flowchart 500 illustrating a transmission flow for Jumbo elements according to various embodiments of the present disclosure. The process starts at step 502. In step 504, it is determined if a single legacy element is enough to carry the control field and the data. If it is determined that it is enough, the process proceeds to step 518 where fragmentation mode 0 (e.g., no fragmentation) is used, and the process ends. Otherwise, the process proceeds to step 506 where it is determined if legacy STAs are expected to parse a Jumbo element. If it is determined to be the case, the process proceeds to step 508 where it is determined if inclusion of a Jumbo element causes the frame to exceed the maximum allowed MPDU size. If it is determined to be the case, the process proceeds to step 514 where fragmentation mode 3 (e.g., mixed fragmentation) is used, and the process ends. Otherwise, the process proceeds to step 512 where fragmentation mode 1 (e.g., legacy fragmentation) is used, and the process ends. On the other hand, if it is determined in step 506 that legacy STAs are not expected to parse the Jumbo element, the process proceeds to step 510 where it is determined whether inclusion of the Jumbo element causes the frame to exceed the maximum allowed MPDU size. If it is determined to be the case, the process proceeds to step 516 where fragmentation mode 2 (e.g., jumbo fragmentation) is used, and the process ends. Otherwise, the process proceeds to step 518 where fragmentation mode 0 (e.g., no fragmentation) is used, and the process ends. While in the above flow, it is shown that step 506 occurs prior to steps 508 or 510, it is not meant to preclude other possible flows. For example, it is possible that either step 508 or 510 may occur first, where it is determined whether inclusion of the Jumbo element causes the frame to exceed the maximum allowed MPDU size, followed by step 506, where it is determined if legacy STAs are expected to parse a Jumbo element.

When legacy STAs are expected to parse the element, it means that legacy STAs may receive host frames and are able to decode them and parse their contents. In this case, backward compatibility needs to be considered. For example, Beacon, Probe Response frames may be expected to carry both legacy elements as well as Jumbo elements, whereas a newly defined frame (e.g., Sensing Measurement Report frame (defined in IEEE 802.11bf)), by definition, may only carry Jumbo elements (e.g., to carry the Sensing Measurement Report).

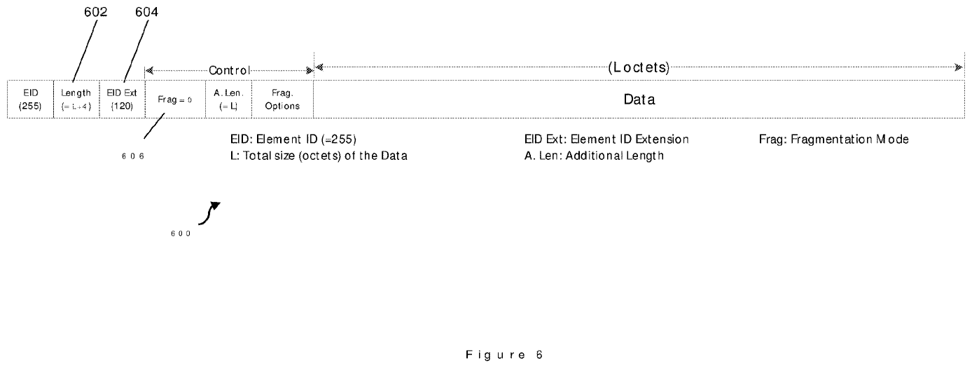

In fragmentation mode 0 (i.e., no fragmentation), L may be the length of the data to be carried in octets. Fragmentation Mode 0 may be used if a single legacy element is enough to carry the control field and data (e.g., if L is less than 252 octets), which means the size of the control field and data field together is less than or equal to 255 octets. This is applicable for both scenarios of illustrations 400 and 408. In Fragmentation Mode 0, the Fragmentation Options field in the Control field is reserved. Additional Length field is set as L, e.g., the number of octets carried in the Data field. When L is less than 252 octets, Length field may indicate the total length of the element excluding the Element ID and Length fields. Referring to Jumbo element 600 of FIG. 6, Element ID Extension field 604 with value 120 is used to identify a Jumbo element. Since L=200 octets, the Jumbo element 600 need not be fragmented, so fragmentation mode field 606 indicates a value 0 (e.g., no fragmentation). Legacy STAs do not understand the Element ID Extension field value 604 (e.g., 120) and uses Length field 602 to discard the element.

Fragmentation mode 0 is also used if a single legacy element is not enough to carry the control field and data, but the data can fit in a single frame/MPDU (e.g., if L is greater than 251 octets but less than L_max (e.g., 11,420 octets) and does not cause the MPDU size to exceed the maximum MPDU size supported by the receiving STA (e.g., 11,454 octets), and when legacy STAs are not expected to parse the element. The maximum MPDU size that a STA can receive depends on the STA's capabilities and may also depend on the frequency band that the STA is operating on. For example, for Very High Throughput (VHT) and High Efficiency (HE) STAs, the maximum MPDU size may be 3895 or 7991 or 11454 octets. A STA advertises the Maximum MPDU size, e.g., using the Maximum MPDU Length field of the VHT Capabilities Information field.

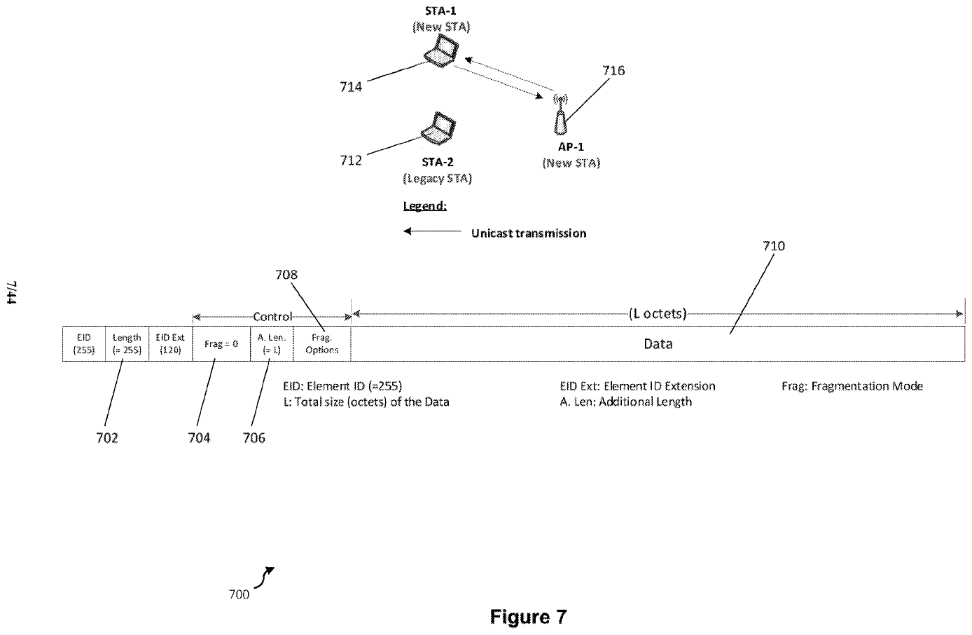

Referring to Jumbo Element 700 of FIG. 7 having Fragmentation Mode 0 in the Fragmentation Mode field 704, Fragmentation Options field 708 in Control field is reserved. Additional Length field 706 is set as L, i.e., the number of octets carried in the Data field 710. Length field 702 is set as 255. New STAs ignores the Length field 702 and extracts the data based on the Additional Length field 708. Alternatively, the Length field 702 may be defined as reserved in this case and can be repurposed for other uses in the future. As the length of the Data field 710=L=750 octets, it does not cause the MPDU size to exceed the maximum MPDU size supported by the receiving STA, e.g., 11,454 octets), so the Jumbo element 700 need not be fragmented. When Legacy STAs (e.g., STA 712) are not expected to parse the element, it means that backward compatibility need not be considered, for example when the host frame is a new frame type that is only understood by New STAs (e.g., 714 and 716), in which case legacy STAs will discard the whole frame and do not need to parse the elements carried in the frame.

Fragmentation Mode 1 (e.g., legacy fragmentation) is used if a single legacy element is not enough to carry the control field and the data, but the data can fit in a single frame/MPDU (e.g., if L is greater than 251 octets but less than L_max (e.g., 11,420 octets) and does not cause the MPDU size to exceed the maximum allowed MPDU size, e.g., 11,454 octets) and when legacy STAs are expected to parse the element. Here, L_max is the maximum payload size that can be carried in a frame/MPDU without the frame exceeding the allowed maximum MPDU size (e.g., 11,454 octets). Legacy STAs being expected to parse the element means that the legacy STAs may receive the host frames and are able to decode them and parse their contents. In this case, backward compatibility needs to be considered.

In Fragmentation Mode 1, the Fragmentation Options field in the Control field is reserved. Additional Length field is set as L, e.g., the number of octets carried in the Data field. The element is fragmented as per 802.11 element fragmentation rule (e.g., 10.28.11 (Element fragmentation) in IEEE 802.11-2020) except that the first three octets of the first fragment is used to carry the Control field such that the first fragment only carries 251 octets of information (versus 254 in baseline), and the number of octets carried in the last fragment, m=(L−251) mod 255. That is, when information is too large to fit in a single element, the element is fragmented into a series of elements consisting of the element that the information does not fit, immediately followed by one or more fragment elements.

Legacy fragmentation rule for Jumbo elements are as follows. M is defined as floor((L+4)/255), e.g., floor(x) gives the largest integer less than or equal to x. N is equal to 1 if ((L−251) mod 255)>0 and equal to 0 otherwise. The element into which the information does not fit is filled with the first portion of information and is termed the leading element. The leading element contains 251 octets of information. This element is immediately followed by M−1 Fragment elements, each containing the next portion of 255 octets of information. If N=1 these elements are immediately followed by the last Fragment element carrying the remaining portion of information. To reconstruct the original information, the portion of information from the leading element shall be concatenated, in order, with the portions of information from the series of fragment elements that follow it.

Accordingly, new STAs may use the Fragmentation Mode field (e.g., indicating a value of 1) to detect that the element has been fragmented per legacy rules and parse the element per the legacy defragmentation rules except that the Control field is omitted from the leading element. Legacy STAs do not understand the Element ID Extension field value (e.g., 120) and will discard all the fragments of the element following baseline parsing rules (e.g., 10.28.12 (Element defragmentation) in IEEE 802.11-2020.

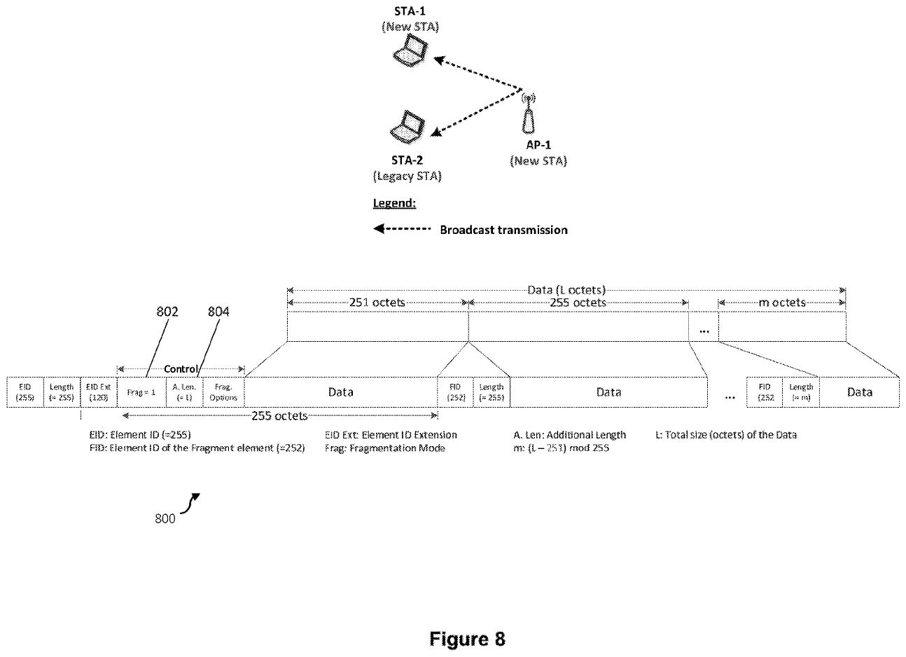

FIG. 8 depicts an illustration of a Jumbo Element 800 with legacy fragmentation according to an embodiment of the present disclosure. Jumbo element 800 (L=1175 octets) is split in 5 legacy fragments. Fragmentation field 802 indicates a value of 1 (e.g., legacy fragmentation). Additional Length field 802 indicates a value of L=1175. Further, in this example, size of first fragment=251 octets, size of next 3 fragments=255 octets each, and size of last fragment (m)=159 octets.

Fragmentation Mode 2 (e.g., jumbo fragmentation) may be used if a single legacy element is not enough to carry the control field and the data, the data cannot fit in a single frame/MPDU (e.g., if L is greater than L_max (e.g., 11,420 octets)) and when legacy STAs are not expected to parse the element.

Jumbo fragmentation rules for Fragmentation Mode 2 are as follows. If the information to be carried in a Jumbo element would result in the host frame to exceed the maximum MPDU size (e.g., 11454 octets), the element shall be split into two or more Jumbo fragments. The Fragment ID field in the Fragmentation Options field uniquely identifies a Jumbo element that is split into multiple fragments and remains the same for all fragments of the same Jumbo element. Each Jumbo fragment shall be carried in a separate frame and shall contain successive portions of the information. Each Jumbo fragment shall be of equal length, except the first fragment and the last fragment, which may be smaller. Each frame that includes a Jumbo fragment except the last fragment shall have a length equal to the maximum MPDU size supported by the STA. The Remaining Fragments field in the Fragmentation Options field identifies the fragments of a Jumbo element and is set to 0 for the last fragment and set to a value between 1 and 15 for a fragment that is not the last fragment. The First Fragment field in the Fragmentation Options field is set to 1 for the first fragment and set to 0 in fragments other than the first fragment. The Additional Length field in the Control field of each Jumbo fragment is set as the number of octets of information carried in the Data field of the Jumbo fragment carried in that frame. The Additional Length field in the Control field of the Jumbo fragments other than the last fragment (e.g., n and p) shall be set such that the frame carrying the fragment shall have a length equal to the maximum MPDU size supported by the receiving STA. If the frame carrying the first Jumbo fragment includes other fields or elements in the frame body, the Additional Length field in the Control field of the Jumbo fragments (e.g., n) may set to a value smaller than the value of the Additional Length field in the Control field of the Jumbo fragments other than the first and the last (e.g., p). If the frame carrying the first Jumbo fragment does not include any other fields or elements as well (e.g., the frame body only carries the first Jumbo fragment) then n=p. The Additional Length field in the Control field of the last Jumbo fragment (e.g., k) is set as the number of remaining octets of the information and the size of the frame carrying the fragment may be smaller than the maximum MPDU size.

Further for Jumbo Fragmentation Mode 2 rules, M is floor((L−n))/p). N is equal to 1 if ((L−n) mod p)>0 and equal to 0 otherwise. The first Jumbo fragment is termed the leading Jumbo fragment. The leading Jumbo fragment contains n octets of information. This fragment is immediately followed by M Jumbo fragment elements, each containing the next portion of p octets of information. If N=1 these elements are immediately followed by the last Jumbo fragment carrying the last portion of information and the number of octets of information carried in the last Jumbo fragment (k)=(L−n) mod p.

For Jumbo defragmentation rules of Fragmentation Mode 2, New STAs use the Fragmentation Mode field (=2) to detect that the Jumbo element has been fragmented per Jumbo fragmentation rules and parse the element as follows. To reconstruct the original information, the portion of information from the leading Jumbo fragment shall be concatenated, in order, with the portions of information from the series of Jumbo fragments that follow it (with matching Fragment ID field value). The defragmentation procedure shall complete when the last Jumbo fragment (identified by the Remaining Fragments field=0) with matching Fragment ID field is received or any element other than a Jumbo fragment element is encountered.

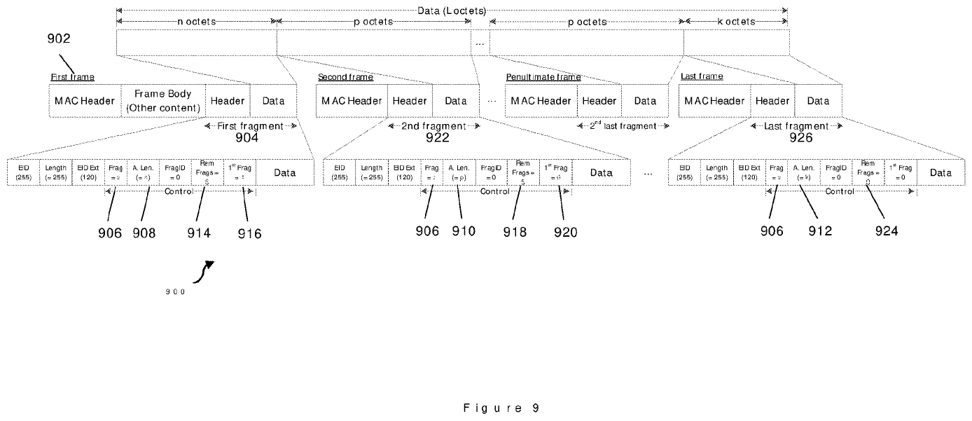

FIG. 9 depicts an illustration of a Jumbo Element with jumbo fragmentation according to an embodiment of the present disclosure. The maximum MPDU size supported by the STA receiving the Jumbo Element 900=11454 octets. The Fragmentation Mode fields 906 in all Jumbo fragments indicate a value of 2 (e.g., jumbo fragmentation), and length of information to be carried (L)=74950 octets. It is assumed that first frame 902 has remaining space to carry 10000 octets e.g., n=10000 octets and an empty frame can carry 11420 octets, e.g., p=11420. M=floor((L−n))/p)=5. Since ((L−n) mod p)>0, N=1.

The Jumbo element 900 is split into 7 Jumbo fragments. Each fragment is carried in a different frame. Additional Length field 908 in the first fragment 904=n=10000 octets. Additional Length fields 910 in each of the next five fragments =p=11420 octets. Additional Length field 912 in the last fragment 926 (k)=(L−n) mod p=7850 octets. Remaining Fragments field 914 in the first fragment 904 with a value of 6 indicates that there are 6 fragments remaining. 1^{st} Fragment field 916 in the first fragment 904 with a value of 1 indicates that the fragment 904 is the first Jumbo fragment. Remaining Fragments field 918 in the 2^{nd} fragment 922 with a value of 5 indicates that there are 5 fragments remaining. 1^{st} Fragment field 920 in the 2^{nd} fragment 922 with a value of 0 indicates that the fragment 922 is not the first Jumbo fragment. Remaining Fragments field 924 in the last fragment 926 with a value of 0 indicates that there are no more fragments remaining e.g., fragment 926 is the last Jumbo fragment.

Fragmentation Mode 3 (e.g., Mixed fragmentation) is used if a single legacy element is not enough to carry the control field and the data, the data cannot fit in a single frame/MPDU (e.g., if L is greater than the maximum allowed MPDU size supported by the receiving STA, L_max (e.g., 11,420 octets)) and when legacy STAs are expected to parse the element. In the mixed fragmentation mode, a two steps fragmentation process is applied to a Jumbo element that would result in the host frame to exceed the maximum MPDU size (e.g., 11454 octets). In Step 1, a Jumbo element is first split into multiple Jumbo fragments following the rules of Jumbo fragmentation (e.g., Fragmentation Mode 2) except that the length of the Data field of each Jumbo fragment also includes the 2 octets overhead (Element ID and Length fields) for each legacy fragment created in Step 2. Each Jumbo fragment is carried in a different frame. In Step 2, each Jumbo fragment whose Additional Length field is larger than 251 octets is further split into two or more legacy fragments following the rules for legacy fragmentation (i.e., Fragmentation Mode 1).

Mixed defragmentation rules are as follows. For Step 1, New STAs use the Fragmentation Mode field (=3) to detect that the element has been fragmented per Mixed fragmentation rules and extract the information from each Jumbo fragment per the legacy defragmentation rules except that the Control field is omitted from the leading element for each Jumbo fragment. For Step 2, to reconstruct the original information, the portion of information from the leading Jumbo fragment shall be concatenated in order, with the portions of information from the series of Jumbo fragments that follow it (e.g., with matching Fragment ID field value). The defragmentation procedure shall be complete when the last Jumbo fragment (identified by the Remaining Fragments field=0) with matching Fragment ID field is received or any element other than a Jumbo fragment element is encountered. Legacy STAs will not be aware that the frames carry fragments of the same Jumbo element and will treat the Jumbo fragments as legacy fragmented elements and discard them per legacy parsing rules.

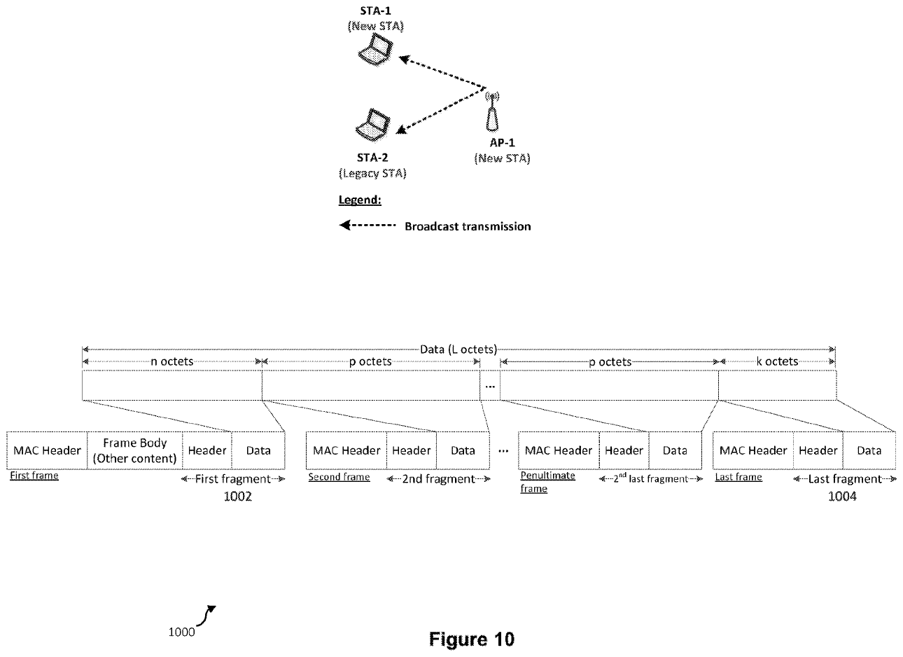

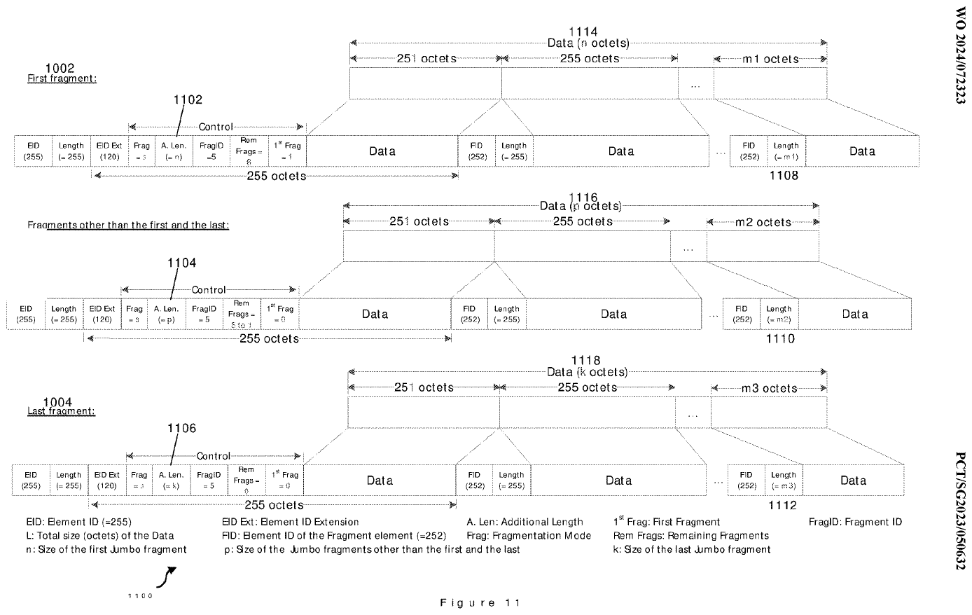

FIG. 10 depicts an illustration of a Jumbo Element 1000 with mixed fragmentation, and FIG. 11 depicts an illustration 1100 of fragments of the Jumbo Element 1000 according to an embodiment of the present disclosure. The Jumbo element 1000 (L=74950 octets) is split into 7 Jumbo fragments. Each fragment is carried in a different frame. Additional Length field 1102 in the first fragment 1002 may be set to be n, which may be equivalent to the total size of data 1114 for the first Jumbo fragment 1002. For example, if the total size of data 1114 for the first Jumbo fragment 1002 is 10000 octets, then n equals 10000 octets. Additional Length fields 1104 in each of the next five fragments (i.e., fragments other than the first and the last) may be set to be p, which may be equivalent to the total size of data 1116 for each of the five Jumbo fragments. For example, if the total size of data 1116 for each of the 5 fragments between the first fragment 1002 and the last fragment 1004 is 11332 octets, then p equals 11332 octets. Additional Length field 1106 in the last fragment 1004 may be set to k, which may be equivalent to the total size of data 1118 for the last Jumbo fragment 1004. For example, if the total size of data 1118 for the last Jumbo fragment 1004 is 8290 octets, then k may equal 8290 octets (i.e., the size of remaining data). Each Jumbo fragment may be further split into two or more legacy fragments. For example, the last legacy fragment of the first Jumbo fragment 1002 has a length field 1108 indicating a length m1=(n−251) mod 255. The last legacy fragment of each of the fragments other than the first Jumbo fragment 1002 and the last Jumbo fragment 1004 has a length field 1110 indicating a length m2=(p−251) mod 255. Further, the last legacy fragment of the last Jumbo fragment 1004 has a length field 1112 indicating a length m3=(k−251) mod 255.

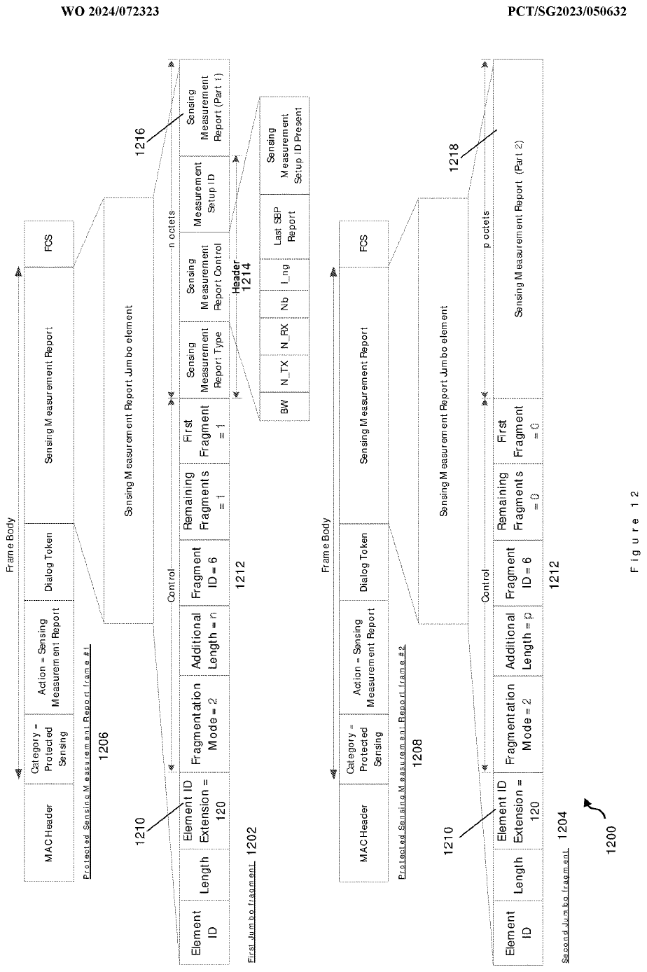

FIG. 12 depicts an illustration 1200 of a Jumbo Element comprising a first Jumbo fragment 1202 and a second Jumbo fragment 1204 used for carrying Sensing Measurement Report according to an embodiment of the present disclosure. In this example, the Sensing Measurement Report is too big to be carried in a single Sensing Measurement Report frame and hence is split into two Jumbo fragments, carried in two Sensing Measurement Report frames 1206 and 1208. Element ID Extension field 1210 indicating a value of 120 identifies a Sensing Measurement Jumbo element and Fragment ID field 1212, e.g., indicating a value of 6, identifies a specific Sensing Measurement Report for a particular Sensing Measurement Instance. The header portion 1214 of the Sensing Measurement Report is only carried in the first Jumbo fragment 1202. Further, Sensing Measurement Report field 1216 carries the first portion of the actual report (e.g., CSI feedback), and Sensing Measurement Report field 1218 carries the second portion of the actual report (e.g., CSI feedback).

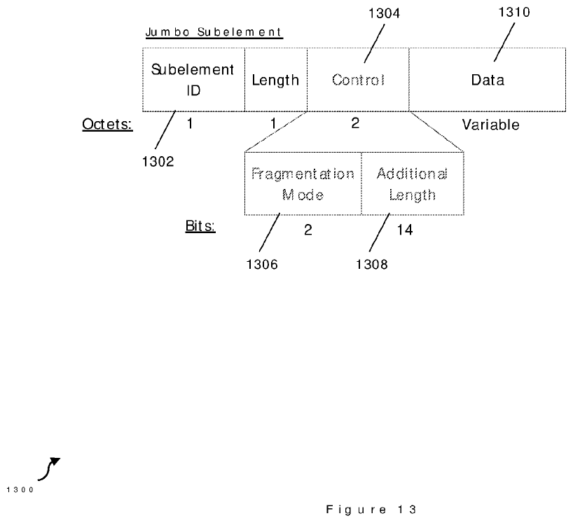

Similar to Jumbo elements, a new variant of subelements (called Jumbo subelements) may be used as a unified information container for information (regardless of size of data to be carried in subelements) within a Jumbo element or within a field in a frame. FIG. 13 depicts an illustration of a Jumbo Subelement 1300 according to an embodiment of the present disclosure. In Jumbo Subelement 1300, the meaning of Subelement ID and Length are same as in per the standards. One or more values of the Subelement ID field 1302 uniquely identify Jumbo subelements (e.g., 0, 1 identify two different Jumbo subelements). One value of Subelement ID is defined as a Fragment ID for Jumbo fragment subelement. (e.g., 254). Additional information required to parse the Jumbo subelement is carried in the Control field 1304 that is present immediately prior to the Data field. For subelement, two fragmentation modes may be defined. For example, Fragmentation Mode field 1306 may indicate a value of 0 for no fragmentation, a value of 1 for legacy fragmentation (e.g., 11be), and values 2 to 3 may be reserved. Further, Additional Length field 1308 may indicate a number of octets carried in Data field 1310. 14 bits of Additional Length field 1308 can signal a Data field length of up to 16,383 octets. A Jumbo subelement shall not cause the host frame to exceed the maximum MPDU size supported by a receiving STA and all fragments of a Jumbo subelement shall be carried in the same MPDU, i.e., fragmentation of Jumbo subelement across MPDUs is not allowed.

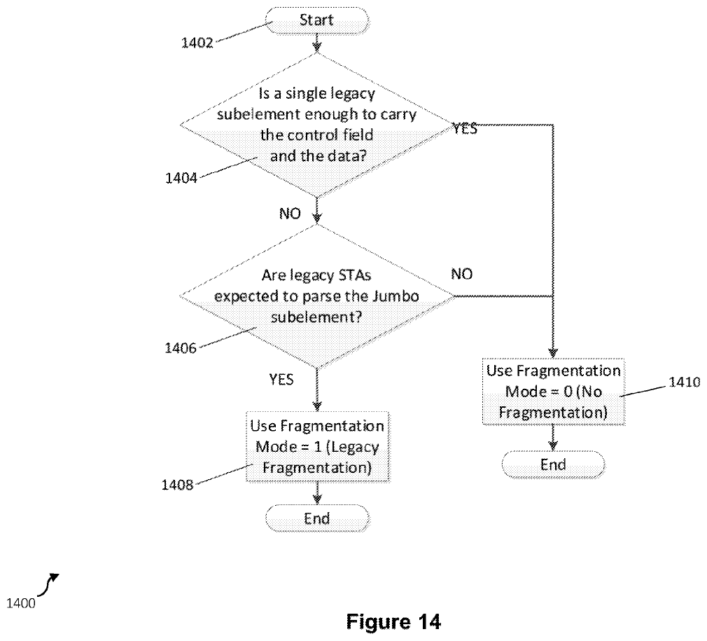

FIG. 14 shows a flowchart 1400 illustrating a process for Jumbo subelements according to various embodiments of the present disclosure. The process begins at step 1402. In the next step 1404, it is determined if a single legacy subelement is enough to carry the control field and the data of a Jumbo subelement. If it is determined to be the case, the process proceeds to step 1410 where fragmentation mode 0 (e.g., no fragmentation) is used and then the process ends. Otherwise, the process proceeds to step 1406 where it is determined if legacy STAs are expected to parse the Jumbo subelement. If legacy STAs are not expected to parse the Jumbo subelement, the process proceeds to step 1410 where fragmentation mode 0 (e.g., no fragmentation) is used and then the process ends. Otherwise, the process proceeds to step 1408 where fragmentation mode 1 (e.g., legacy fragmentation) is used, and then the process ends.

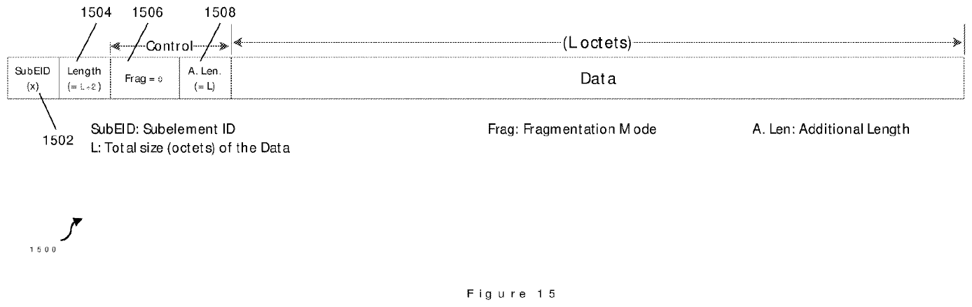

For Jumbo subelements, Fragmentation Mode 0 is used if a single legacy subelement is enough to carry the control field and the data (e.g., if L is less than 253 octets). This is applicable for both scenarios in FIGS. 4A and 4B. Additional Length field is set as L, e.g., the number of octets carried in the Data field. When L is less than 252 octets, Length field indicates the total length of the element excluding the Element ID and Length fields. Referring to Jumbo Subelement 1500 of FIG. 15, Subelement ID field 1502 indicating a value x (e.g., 0) is used to identify a Jumbo subelement. Let L be the length of the data to be carried (e.g., in octets). Length field 1504 indicates a value of L+2, Fragmentation Mode field 1506 indicates 0 (e.g., no fragmentation) and Additional Length field 1508 indicates a value of L. In this example, L=240 octets. Thus, the Jumbo subelement 1500 need not be fragmented.

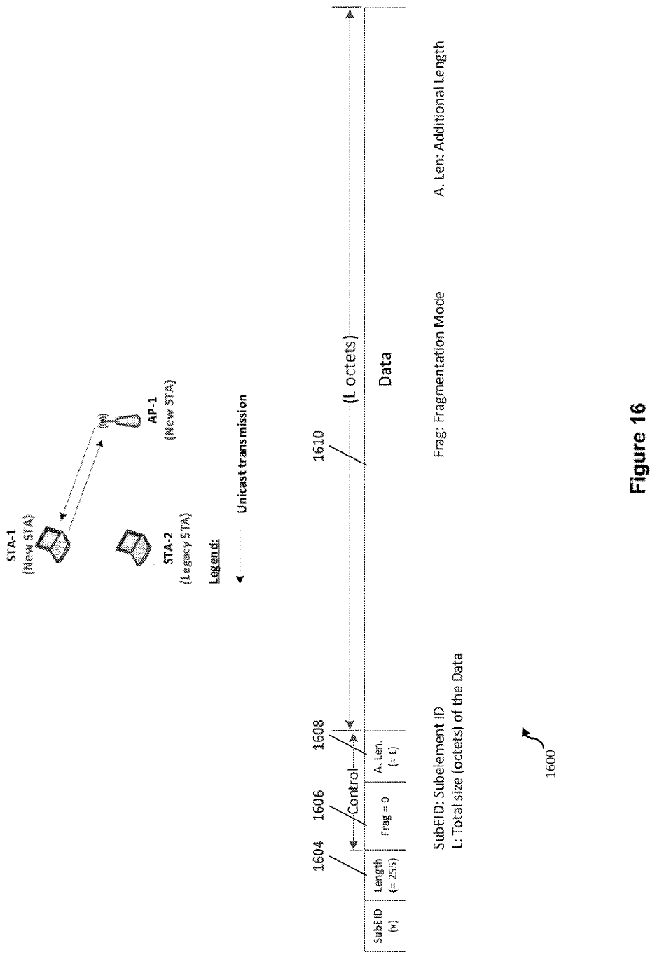

Fragmentation Mode 0 is also used even if a single legacy subelement is not enough to carry the control field and the data, but when legacy STAs are not expected to parse the element. Referring to Jumbo Subelement 1600 of FIG. 16, Additional Length field 1608 is set as L, i.e., the number of octets carried in Data field 1610. Length field 1604 is set as 255. New STAs ignores the Length field 1604 and extracts the data based on the Additional Length field 1608. Alternatively, the Length field may be defined as reserved in this case and can be repurposed for other uses in the future. In this case, since L=750 octets, the Jumbo Subelement 1600 need not be fragmented.

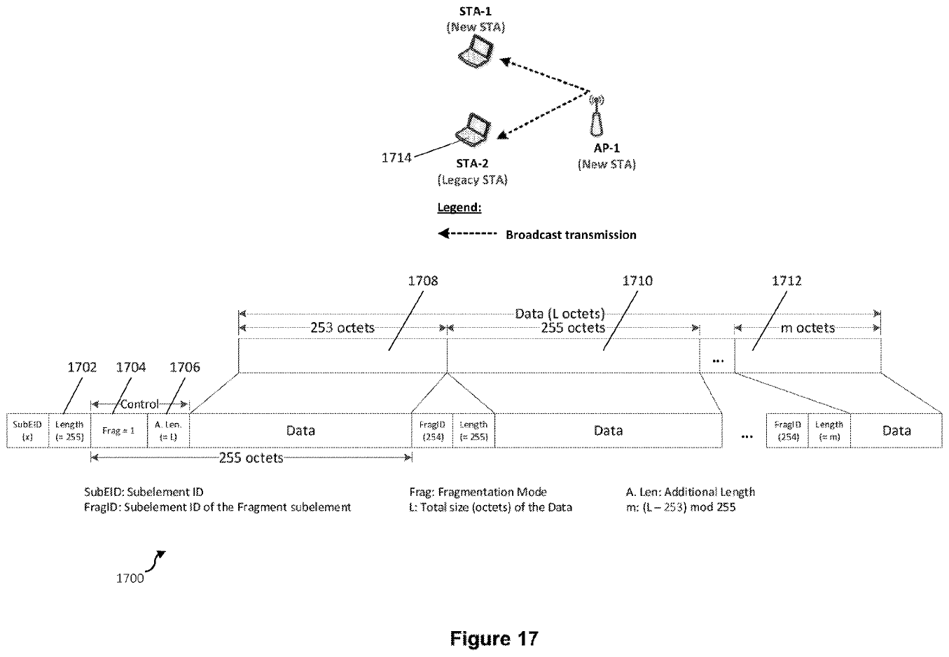

Fragmentation Mode 1 is used if a single legacy subelement is not enough to carry the control field and the data, and when legacy STAs (e.g., STA 1714 in FIG. 17) are expected to parse the subelement. Additional Length field is set as L, e.g., the number of octets carried in the Data field. The data is split across a series of subelements consisting of the Jumbo subelement, immediately followed by one or more Fragment subelements (Subelement ID set to 254). The first two octets of the Jumbo subelement is used to carry the Control field such that the subelement only carries 253 octets of information (versus 255 in baseline), and the number of octets carried in the last Fragment subelement, m=(L−253) mod 255.

Legacy fragmentation rule for Jumbo subelements may be as follows. M is floor((L+2)/255). N is equal to 1 if ((L−253) mod 255)>0 and equal to 0 otherwise. The subelement into which the information does not fit is filled with the first portion of information and is termed the leading subelement. The leading subelement contains 253 octets of information. This subelement is immediately followed by M−1 Fragment subelements, each containing the next portion of 255 octets of information. If N=1, these subelements are immediately followed by the last Fragment subelement carrying the remaining portion of information. New STAs use the Fragmentation Mode field (=1) to detect that the subelement has been fragmented per legacy rules and parse the subelement per the legacy defragmentation rules. To reconstruct the original information, the control field is removed from the Data field of the leading subelement and the portion of information from the leading subelement shall be concatenated in order, with the portions of information from the series of Fragment subelements that follow it. The defragmentation procedure shall complete when any subelement other than a Fragment subelement is encountered or the last Fragment subelement is received. Legacy STAs do not understand the Subelement ID field value and will discard all the fragments of the subelement following baseline parsing rules.

For example, Jumbo Subelement 1700 of FIG. 17 (L=1175 octets) is split in 5 fragments. Additional Length field 1706 indicates a value of L=1175 octets. Size of first fragment 1708 is 253 octets, each size of next 3 fragments 1710=255 octets each, and size of last fragment 1712 is m=(L−253) mod 255=157 octets.

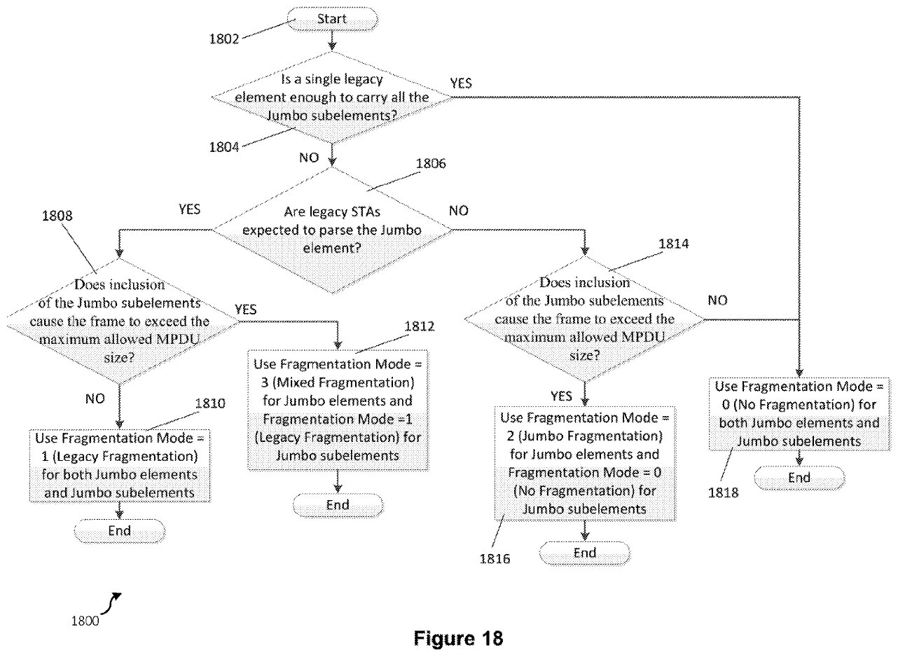

FIG. 18 shows a flowchart illustrating a transmission flow for Jumbo Elements carrying Jumbo Subelements according to various embodiments of the present disclosure. The process begins at step 1802. In step 1804, it is determined if a single legacy element is enough to carry all the Jumbo subelements. If it is determined to be the case, the process proceeds to step 1818 where Fragmentation Mode=0 (e.g., no fragmentation) is used for both Jumbo elements and Jumbo subelements, and the process ends. Otherwise, the process proceeds to step 1806 where it is determined whether legacy STAs are expected to parse the Jumbo element. If it is determined to be the case, the process proceeds to step 1808 where it is determined whether inclusion of the Jumbo subelements cause the frame to exceed the maximum allowed MPDU size. If it is determined to be the case, the process proceeds to step 1812 where Fragmentation Mode=3 (e.g., mixed fragmentation) is used for Jumbo elements and Fragmentation Mode=1 (e.g., legacy fragmentation) is used for Jumbo subelements, and the process ends. Otherwise, the process proceeds to step 1810 where Fragmentation Mode=1 (e.g., legacy fragmentation) is used for both Jumbo elements and Jumbo subelements, and the process ends. If, at step 1806, it is determined that legacy STAs are not expected to parse the Jumbo element, the process proceeds instead to step 1814 where it is determined whether inclusion of the Jumbo subelements cause the frame to exceed the maximum allowed MPDU size. If it is determined to be the case, the process proceeds to step 1816 where Fragmentation Mode=2 (e.g., Jumbo fragmentation) is used for both Jumbo elements and Fragmentation Mode=0 (e.g., no fragmentation) is used for Jumbo subelements, and the process ends. Otherwise, the process proceeds to step 1818 where Fragmentation Mode=0 (e.g., no fragmentation) is used for both Jumbo elements and Jumbo subelements, and the process ends. While in the above flow, it is shown that step 1806 occurs prior to steps 1808 or 1814, it is not meant to preclude other possible flows. For example, it is possible that either step 1808 or 1814 may occur first, where it is determined whether inclusion of the Jumbo subelements causes the frame to exceed the maximum allowed MPDU size, followed by step 1806, where it is determined if legacy STAs are expected to parse a Jumbo element.

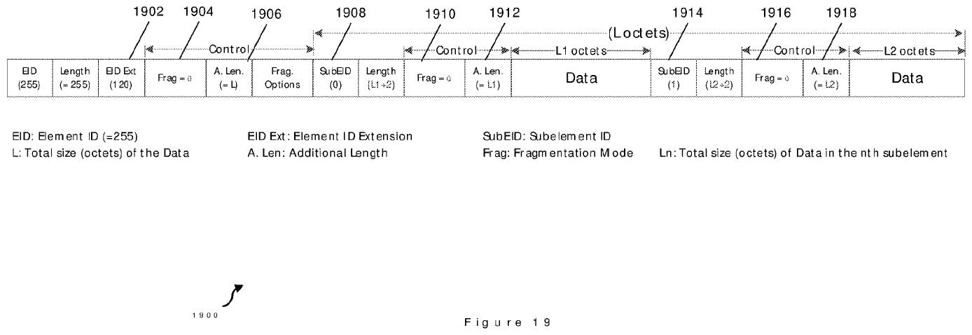

In a case of Jumbo elements carrying Jumbo subelements, when Legacy STAs are not expected to parse the Jumbo element and Jumbo subelements, and a single Jumbo element is sufficient to carry all Jumbo subelements, or if a single legacy element is enough to carry all the Jumbo subelements, Fragmentation Mode=0 is used for both the Jumbo element and Jumbo subelements. Referring to Jumbo element 1900 of FIG. 19, two Jumbo subelements (ID=0 & 1 in Subelement ID (SubEID) fields 1908 and 1914 respectively) are defined within the Jumbo element 1900 (ID=120 as indicated in Element ID Extension (EID Ext) field 1902). The Jumbo element 1900 carries two Jumbo subelements with lengths L1=3500 (as indicated in Additional Length field 1912) and L2=5400 octets (as indicated in Additional Length field 1918) respectively. Length of the Data field in the Jumbo element 1900 is (L)=L1+L2+2*4=8908 octets. Since a single Jumbo element is enough to carry both Jumbo subelements, the Fragmentation Mode field 1904 in the Control field of the Jumbo element is set as 0 (No Fragmentation). Further, Fragmentation Mode=0 is also used for both the Jumbo subelements (as indicated in Fragmentation Mode fields 1912 and 1916).

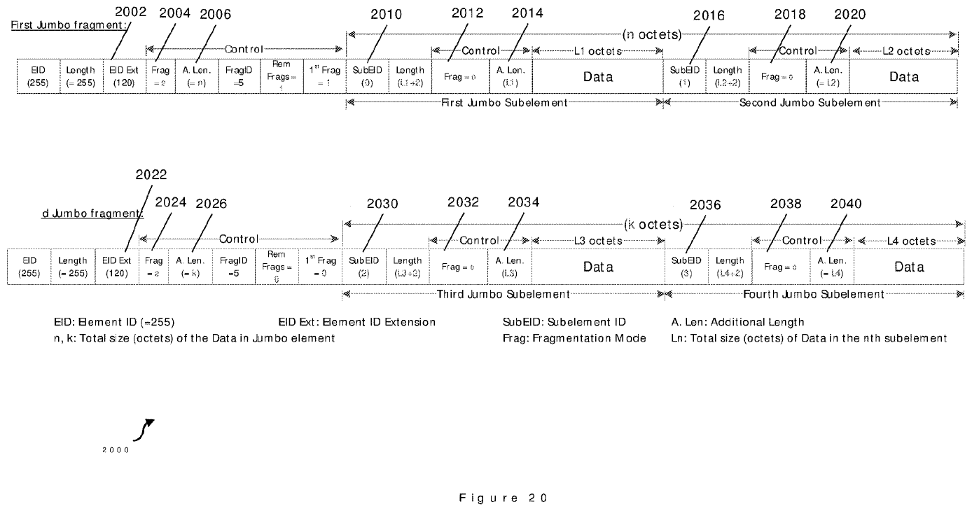

When Legacy STAs are not expected to parse the Jumbo element and Jumbo subelements, and a single Jumbo element is not sufficient to carry all Jumbo subelements, Fragmentation Mode=0 is used for the Jumbo subelements and Fragmentation Mode=2 (Jumbo Fragmentation) is used for the Jumbo element. For example, a single Jumbo element is not sufficient if the inclusion of the element causes the host frame to exceed the maximum MPDU size supported by the STA. Referring to Jumbo element 2000 of FIG. 20, Four Jumbo subelements ID=0, 1, 2 & 3 (as indicated in SubEID fields 2010, 2016, 2030 and 2036 respectively) are defined within a Jumbo element (ID=120 as indicated in EID Ext fields 2002 and 2022) with lengths L1=3500, L2=5400, L3=4600 and L4=5500 octets respectively (as indicated in Additional Length fields 2014, 2020, 2034 and 2040 respectively). Since a single Jumbo element is not enough to carry the four Jumbo subelements, the Jumbo element is split into two Jumbo fragments using Jumbo Fragmentation (e.g., the Fragmentation Mode fields 2004 and 2024 in the Control field of the Jumbo fragments is set as 2 (Jumbo Fragmentation)). The first Jumbo fragment carries the first two Jumbo subelements (ID=0 & 1) while the second Jumbo fragment carries the next two Jumbo subelements (ID=2 & 3); length of the Data field in the first Jumbo fragment (n)=L1+L2+2*4=8908 octets; length of the Data field in the second Jumbo fragment (k)=L3+L4+2*4=10108 octets. The two Jumbo fragments are carried in two different frames. Further, Fragmentation Mode=0 (no fragmentation as indicated in Fragmentation Mode fields 2012, 2018, 2032 and 2038) are used for the four Jumbo subelements. It is to be noted that when Jumbo elements only carry Jumbo subelements, the frame carrying the Jumbo element is not required to be equal to the maximum MPDU size supported by the receiving STA.

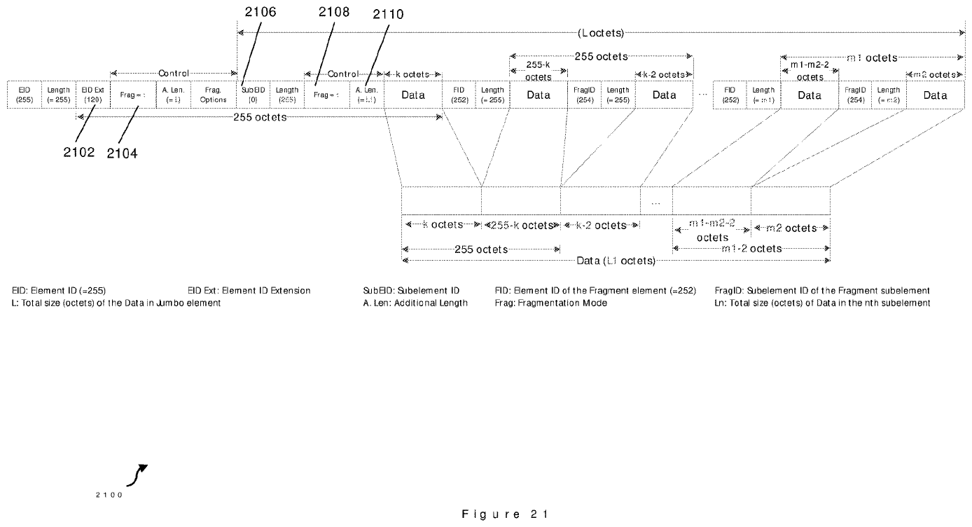

When Legacy STAs are expected to parse the Jumbo element and Jumbo subelements, and a single Jumbo element is sufficient to carry all Jumbo subelements, Fragmentation Mode=1 (Legacy Fragmentation) is used for both the Jumbo element and Jumbo subelements. Referring to Jumbo element 2100 of FIG. 21, one Jumbo subelement (ID=0 as indicated in SubEID field 2106) is defined within a Jumbo element (ID=120 as indicated in EID Ext field 2102) with length L1=3500 (as indicated in Additional Length field 2110). Since a single Jumbo element is enough to carry all subelements, both the Jumbo element and the Jumbo Subelement are fragmented using the Legacy Fragmentation mode (e.g., Fragmentation Mode field 2104 in the Control field of the Jumbo element 2100 and Fragmentation Mode field 2108 in the Jumbo subelement is set as 1 (Legacy fragmentation)).

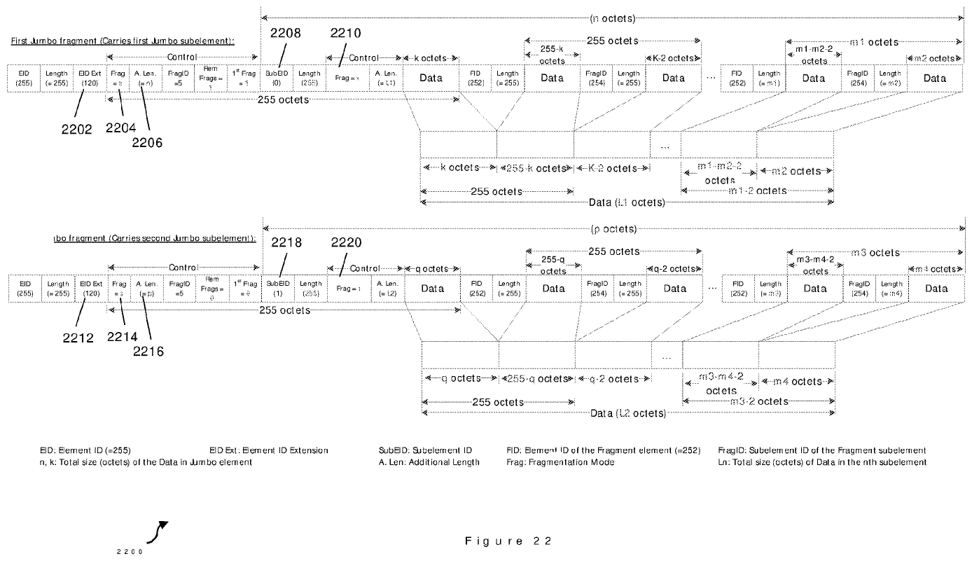

When Legacy STAs are expected to parse the Jumbo element and Jumbo subelements, and a single Jumbo element is not sufficient to carry all Jumbo subelements, Fragmentation Mode=1 (Legacy Fragmentation) is used for the Jumbo subelements and Fragmentation Mode=3 (Mixed Fragmentation) is used for the Jumbo elements. Referring to Jumbo element 2200 of FIG. 22, two Jumbo subelements (ID=0 & 1 as indicated in SubEID fields 2208 and 2218 respectively) are defined within a Jumbo element (ID=120 as indicated in EID Ext fields 2202 and 2212) with lengths n=9500 octets (as indicated in Additional Length field 2206) and p=8700 octets (as indicated in Additional Length field 2216) respectively. Since a single Jumbo element is not enough to carry all subelements, the Jumbo Subelements are fragmented using the Legacy Fragmentation mode (i.e., Fragmentation Mode fields 2210 and 2220 in the Control field of the Jumbo subelements is set as 1 (Legacy fragmentation)) while Jumbo fragmentation is used for the Jumbo element (i.e., the Fragmentation Mode fields 2204 and 2214 in the Control field of the Jumbo element 2200 is set as 3).

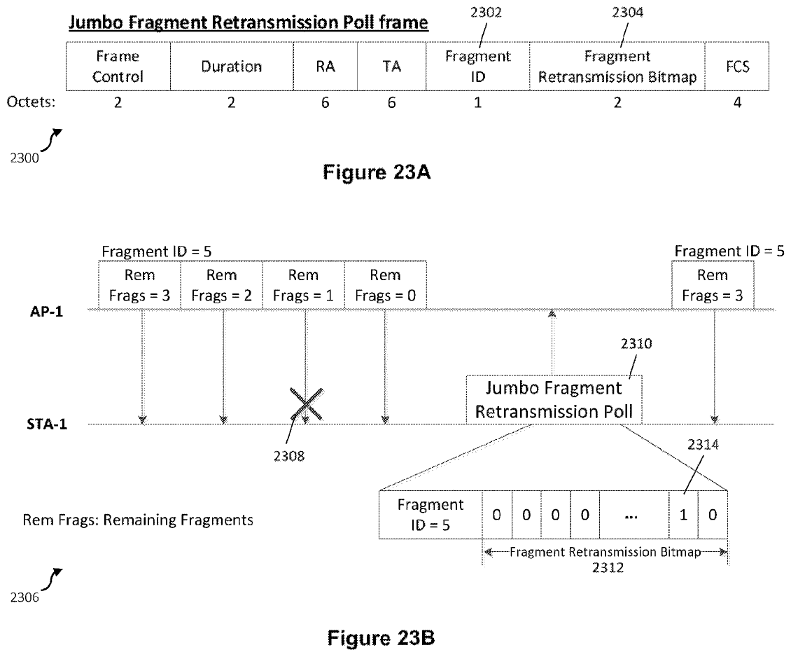

FIG. 23A depicts an example illustration of a Jumbo Fragment Retransmission Poll frame 2300 according to an embodiment of the present disclosure. Jumbo Fragment Retransmission Poll frame 2300 is used to solicit selective retransmission of Jumbo fragment(s) in case of reception failure. Selective retransmission of Jumbo fragment(s) is more useful when the ack policy of the host frame is set as “No Ack”, or the frame type of the host frame, by default, does not solicit an Ack frame, for example when the frame is an Action No Ack frame. Fragment ID field 2302 identifies the Jumbo element whose fragment is solicited for retransmission. The Fragment Retransmission Bitmap field 2304 indicates the Jumbo fragment(s) that is requested for retransmission. If the bit in position n (n=0 for least significant bit (LSB) and n=15 for most significant bit (MSB)) is 1, then the Jumbo fragment with the Remaining Fragments field in the Fragmentation Option field in the Control field equal to n is requested. Referring to illustration 2306 of FIG. 23B, four Jumbo fragments are carried in an A-MPDU, one fragment per MPDU. Transmission of a 3^{rd} Jumbo fragment fails (as indicated in reference 2308) and is requested for retransmission using a Jumbo Fragment Retransmission Poll frame 2310. Bit in position 1 2314 of Fragment Retransmission Bitmap field 2312 is set as 1 to indicate that the Jumbo fragment with the Remaining Fragments field=1 is requested for retransmission.

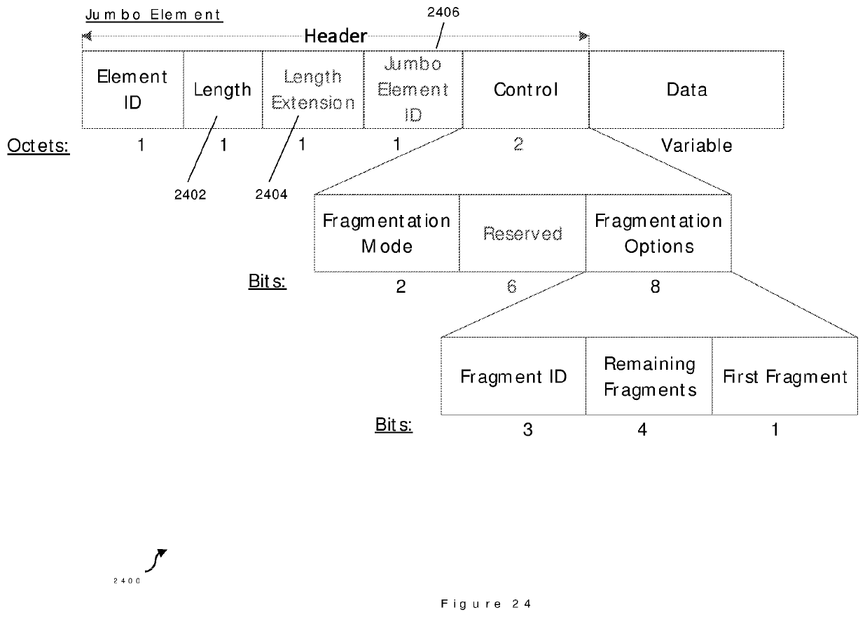

FIG. 24 depicts a Jumbo Subelement 2400 of an alternative format according to an embodiment of the present disclosure. While meaning of the fields in Jumbo Subelement 2400 are generally the same as the Jumbo elements described in the earlier figures, some differences are as follows. A reserved value of Element ID field 2406 (e.g., 254) uniquely identifies the Jumbo element variant. The octet immediately following the Length field 2402 is used as Length Extension field 2404 and, together with the Length field 2402, indicates the size of the Jumbo element 2400. The octet immediately following Length Extension field 2404 is used as Jumbo Element ID field 2406 and identifies various types of Jumbo elements.

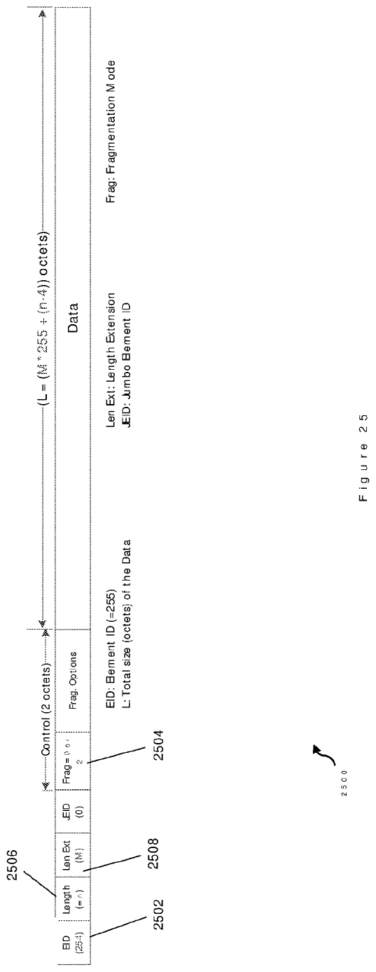

An Element ID field with value 254 may be used to identify a Jumbo element variant e.g., Element ID field value 254 is a reserved value to identify a jumbo element. Jumbo Element ID=0, 1, 2 etc. identify different types of Jumbo elements. Referring to Jumbo Element 2500 of FIG. 25 with Element ID field 2502=254, Fragmentation Mode field 2504 indicates 0 or 2 to indicate no fragmentation or jumbo fragmentation respectively. Further, Length field 2506 indicates n while Length Extension field 2508 indicates M. L is a total size (octets) of data of the Jumbo Element 2500 where L=(M*255+n−1)) octets.

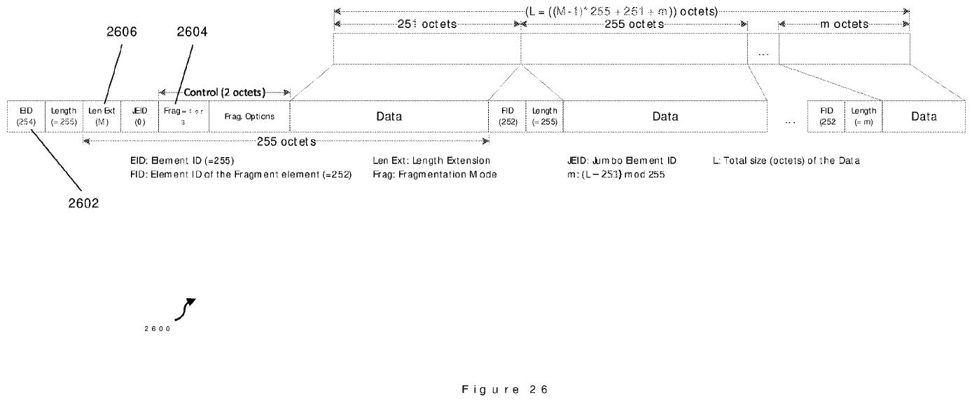

Referring to Jumbo Element 2600 of FIG. 26 with Element ID field 2602=254, Fragmentation Mode field 2604 indicates 1 or 3 to indicate legacy fragmentation or mixed fragmentation respectively. Further, Length Extension field 2606 indicates M where M is M+1 is the number of Jumbo fragments that the Jumbo element is split into. L is a total size (octets) of data of the Jumbo Element 2600 where L=((M−1)*255+251+m)) octets and m=(L−251) mod 255.

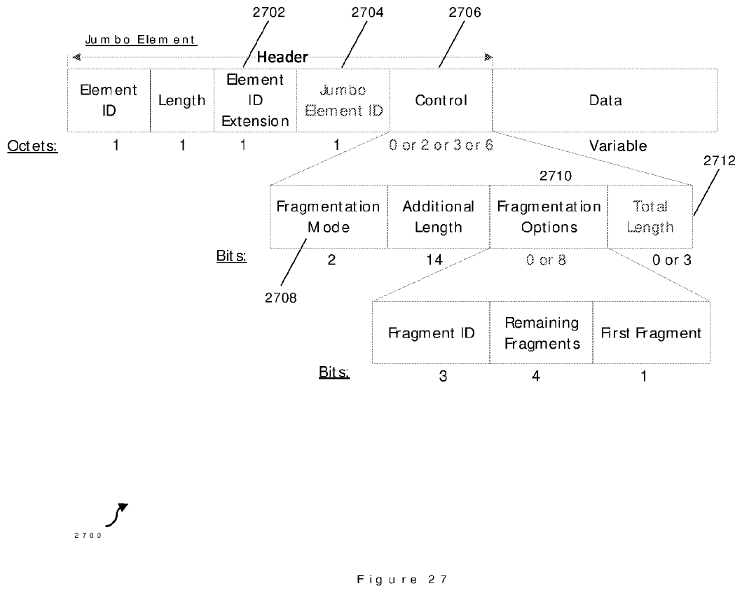

In an embodiment, a new variant of Jumbo element may be used as a unified container for information (e.g., regardless of size of data). In this variation, meaning of the fields are same as in the earlier discussed jumbo elements except for the following. Referring to Jumbo element 2700 of FIG. 27, a single value of Element ID Extension field 2702 may uniquely identify the Jumbo element variant (e.g., 96). Jumbo Element ID field 2704 that immediately follows the Element ID Extension field 2702 may identify various types of Jumbo elements. Control field 2706 is absent when a single legacy element is sufficient to carry the Jumbo Element ID and data (e.g, L<254 octets).

The Control field 2706 is present when a single legacy element is not sufficient to carry the Jumbo Element ID and the data (e.g., L>253 octets). Fragmentation Options field 2710 and Total Length field 2712 are absent when Fragmentation Mode=0 or 1 in Fragmentation Mode field 2708 and in this case the Control field is 2 Octets long. The Total Length field 2712 indicates the total number of octets carried in the Jumbo element 2700 across all of its fragments. The information can be used by a receiving STA to prepare resources (e.g., memory space) for the data carried in the Jumbo element 2700 in advance. When the Fragmentation Options field 2710 is present, the Total Length field 2712 is optionally present when Fragmentation Mode=2 or 3 in the Fragmentation Mode field 2708. For example, the Total Length field 2712 is present in the first Jumbo fragment and indicates the total number of octets carried in the Jumbo element 2700 across all of its fragments and, in this case, the Control field 2706 is 6 Octets long. In another example, the Total Length field 2712 is absent in Jumbo fragments other than the first fragment and in this case the Control field 2706 is 3 Octets long.

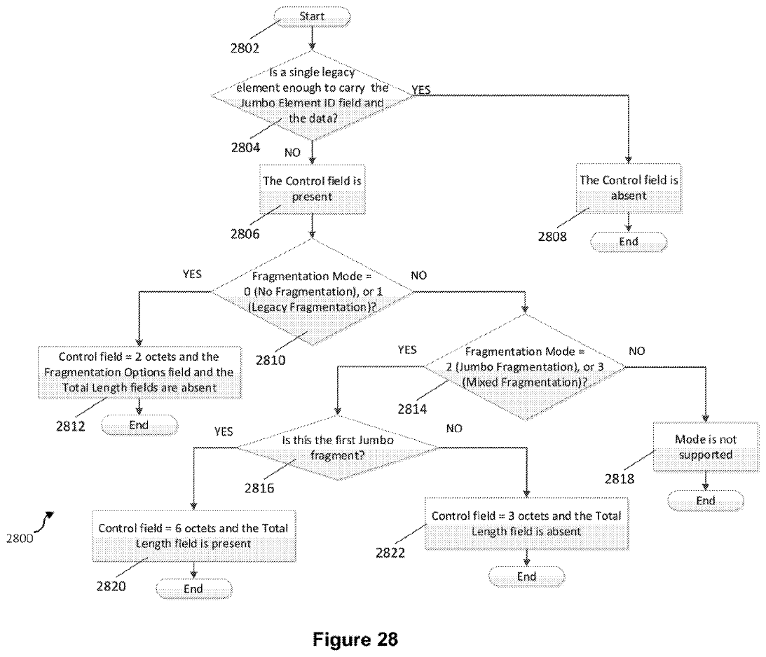

FIG. 28 shows a flowchart 2800 illustrating a transmission flow for a Jumbo Element variant according to an embodiment of the present disclosure. The process begins at step 2802. In a step 2804, it is determined if a single legacy element is enough to carry a Jumbo Element ID field and data of the Jumbo Element. If it is determined to be the case, the process proceeds to step 2808 where Control field is omitted, and the process ends. Otherwise, the process proceeds to step 2806 where the Control field is present, and the process further proceeds to step 2810 where it is determined if Fragmentation Mode=0 (no fragmentation) or 1 (legacy fragmentation). If it is determined that the Fragmentation Mode is either 0 or 1, the process proceeds to step 2812 where the Control field is set to 2 octets and Fragmentation Options field and Total Length field are omitted, and the process ends. Otherwise, the process proceeds instead to step 2814 where it is determined if Fragmentation Mode=2 (Jumbo fragmentation) or 3 (mixed fragmentation). If it is determined that Fragmentation Mode is not 2 or 3, the process proceeds to step 2818 where Mode is not supported, and the process ends. Otherwise, the process proceeds to step 2816 where it is determined if this is a first Jumbo element. If it is determined to be the case, the process proceeds to step 2820 where the Control field is set to 6 octets and the Total Length field is present, and the process ends. Otherwise, the process proceeds to step 2822 where the Control field is set to 3 octets and the Total Length field is omitted, and the process ends.

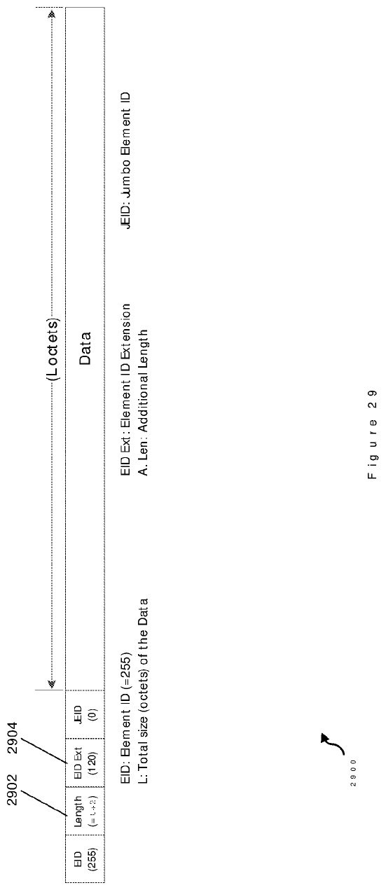

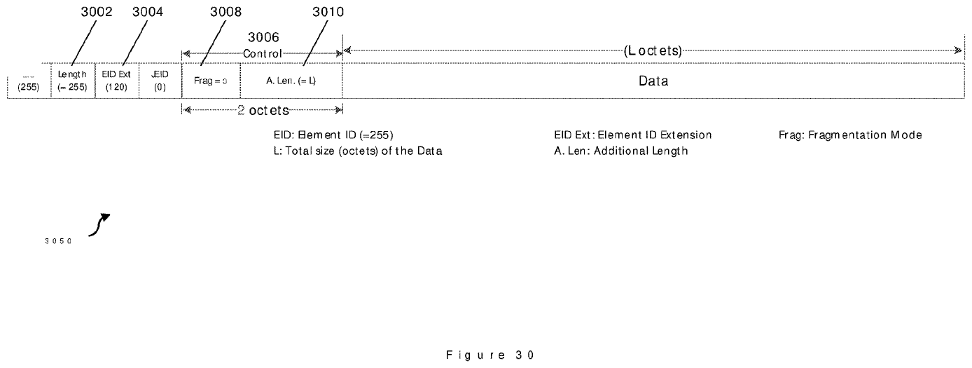

In an embodiment, Element ID Extension field with a value 120 is used to identify a Jumbo element variant. Jumbo Element ID=0, 1, 2 etc. may identify different types of Jumbo elements. Referring to Jumbo Element 2900 of FIG. 29 where L=200 octets, Control field is absent (since L is only 200 octets). A receiving New STA decides based on Length field 2902 (where L<254) that the Control field is absent. Legacy STAs do not understand Element ID Extension field 2904 value (e.g., 120) and uses the Length field 2902 to discard the element. Referring to Jumbo Element 3000 of FIG. 30 where L=750 loctets and EID Extension field 3004 indicates a value of 120, legacy STAs are not expected to parse the Jumbo element 3000. Control field 3006 is 2 octets (Frag. Options and Total Length fields are absent)). In the Control field 3006, Fragmentation Mode field 3008 indicates a value of 0 (e.g., no fragmentation) and Additional Length field indicates L (e.g., total size in octets of the data in the Jumbo Element 3000 is L). A receiving New STA decides based on Length field 3002 (L>253) that the Control field 3006 is present.

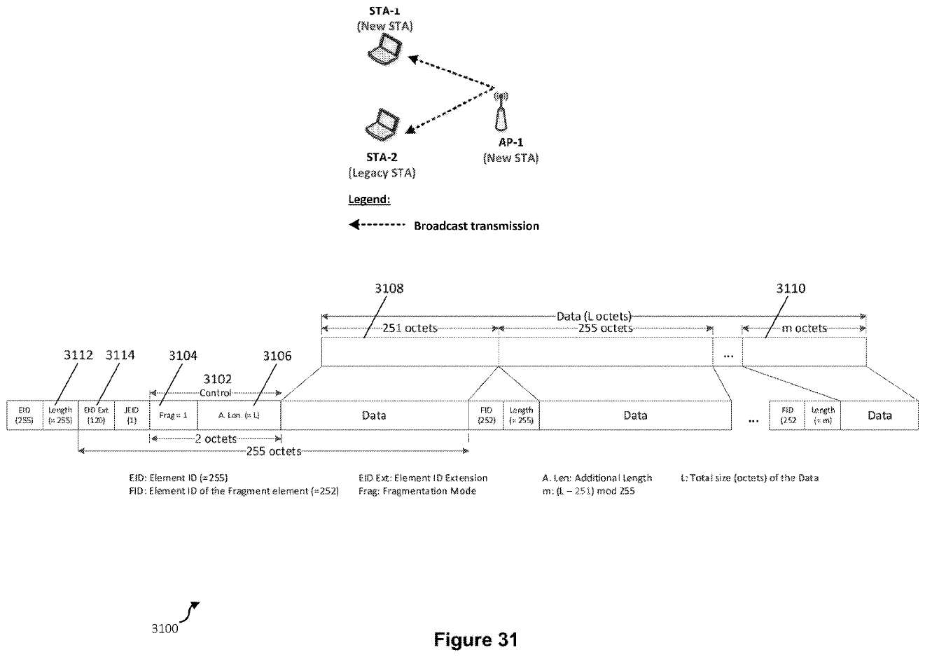

FIG. 31 depicts an example Jumbo Element 3100 with legacy fragmentation according to an embodiment of the present disclosure. Legacy STAs are expected to parse the Jumbo Element 3100 (L=1175 octets) which is split in 5 legacy fragments. Length field 3112 indicates a value of 255 and EID Extension field 3114 indicates a value of 120 (e.g., indicating Jumbo Element 3100 as a Jumbo element variant). Additional Length field 3106 indicates a value of 1175 (e.g., 1175 octets). Control field 3102 is 2 octets (Frag. Options and Total Length are absent)). Fragmentation Mode field 3104 indicates a value of 1 (e.g., Legacy fragmentation). Size of first fragment 3108=251 octets, size of next 3 fragments=255 octets each and size of last fragment 3110 (m)=159 octets, where m=(L−251) mod 255.

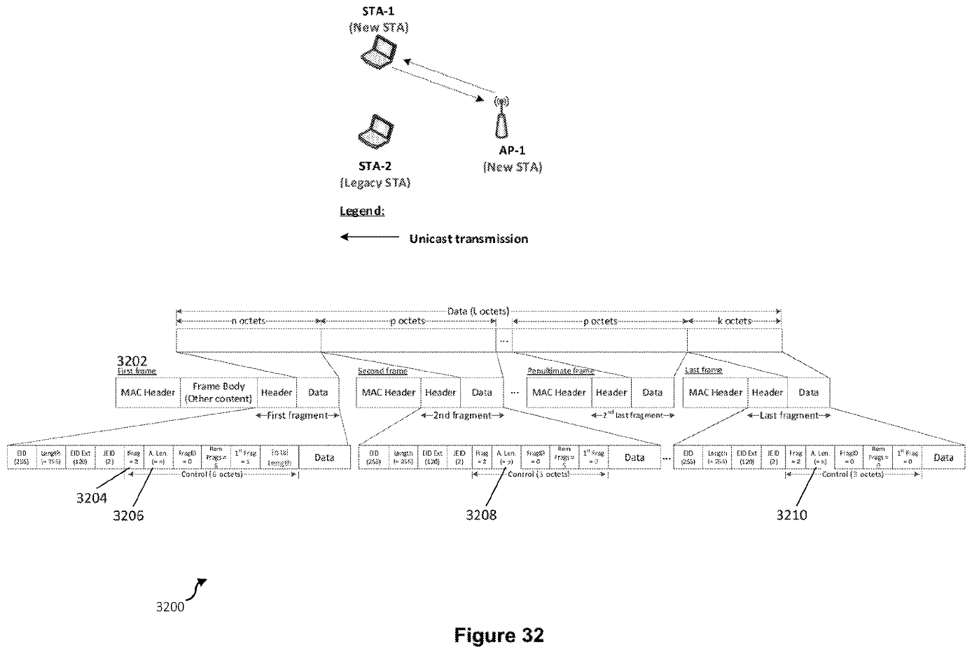

FIG. 32 depicts an example Jumbo Element 3200 with jumbo fragmentation according to an embodiment of the present disclosure. Length of information to be carried (L)=74950 octets and legacy STAs are not expected to parse the Jumbo element 3200. In this example, first frame 3202 has remaining space to carry 10000 octets e.g., n=10000 octets and an empty frame can carry 11420 octets, e.g., p=11420. M=floor((L−n))/p)=5. Since ((L−n) mod p)>0, N=1. The Jumbo element 3200 is split in 7 Jumbo fragments e.g., Fragmentation Mode field 3204 indicates a value of 2 (Jumbo fragmentation). Each fragment is carried in a different frame. Additional Length field 3206 in the first fragment=n=10000 octets. Total length field is present in the first fragment and=74950 octets. Additional Length field 3208 in each of the next five fragment=p=11420 octets. Additional Length field 3210 in the last fragment (k)=(L−n) mod p=7850 octets.

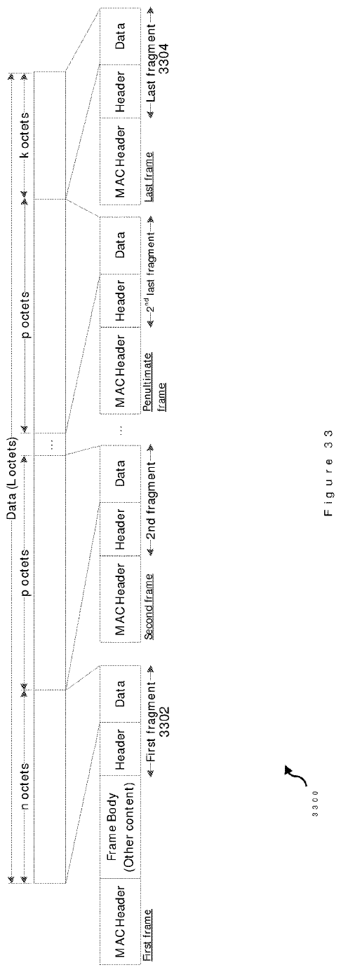

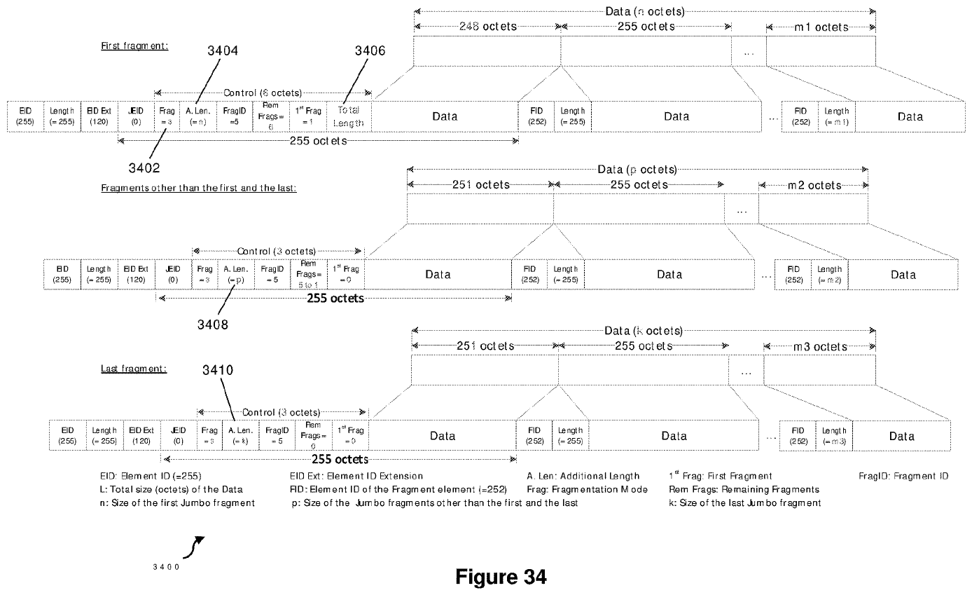

FIG. 33 depicts an example Jumbo Element 3300 with mixed fragmentation and FIG. 34 depicts an illustration 3400 of fragments of the Jumbo Element 3300 according to an embodiment of the present disclosure. Legacy STAs are expected to parse the Jumbo element 3300. Jumbo element 3300 (L=74950 octets) is split in 7 Jumbo fragments. Fragmentation Mode field 3402 indicates a value of 3 (Mixed fragmentation). Each Jumbo fragment is further split into legacy fragments and each Jumbo fragment carried in a different frame. Additional Length field 3404 in the first Jumbo fragment 3302 (n)=10000 octets. Total length field 3406 is present in the first fragment 3302 and indicates a value of 74950 octets. The number of octets carried in the last legacy fragment of the first Jumbo fragment 3302, m1=(n−248) mod 255. Additional Length field 3408 in each of the next five fragments (p)=11332 octets. The number of octets carried in the last legacy fragment in each of the next five Jumbo fragments, m2=(p−251) mod 255. Additional Length field 3410 in the last Jumbo fragment 3304 (k)=8290 octets. The number of octets carried in the last legacy fragment of the last Jumbo fragment 3304, m3=(k−251) mod 255.

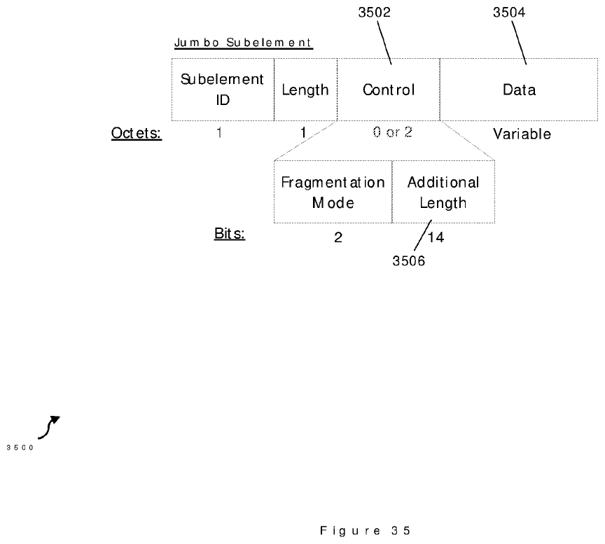

Similar to Jumbo elements, a new variant of subelements (called Jumbo subelements) may be used as unified container for information (regardless of size of data to be carried in subelements) within a Jumbo element or within a field in a frame. Referring to Jumbo Subelement 3500 of FIG. 35, meaning of the fields are same as the Jumbo elements as per previous embodiments, except that Control field 3502 is absent when a single legacy subelement is sufficient to carry the data (e.g., L<256 octets), but present in all other cases. 14 bits of Additional Length field 3506 can signal a Data field length (e.g., length of Data field 3504) of up to 16,383 octets.

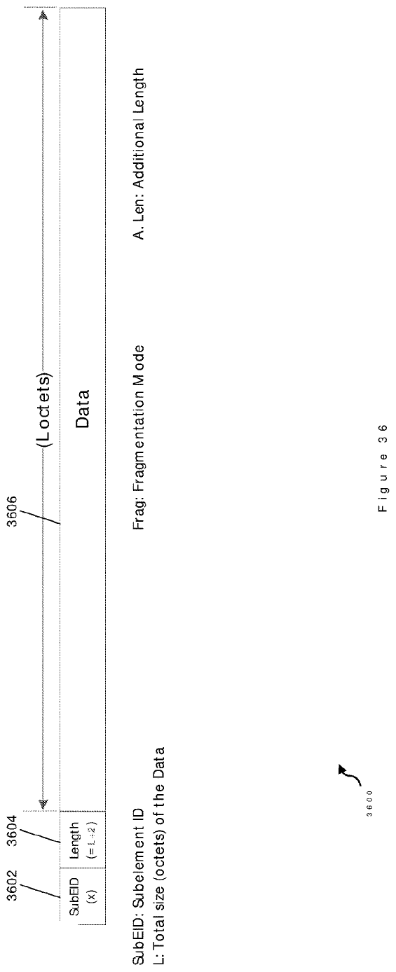

FIG. 36 depicts an example Jumbo Subelement 3600 without a control field according to an embodiment of the present disclosure. Subelement ID field 3602 indicates a value x which is used to identify a Jumbo subelement. In this example, L is the length of the data to be carried in octets (e.g., length of Data field 3606). Since L in this case is 240 octets, Control field is absent. A receiving New STA decides based on Length field 3604 (L<256) that the Control field is absent.

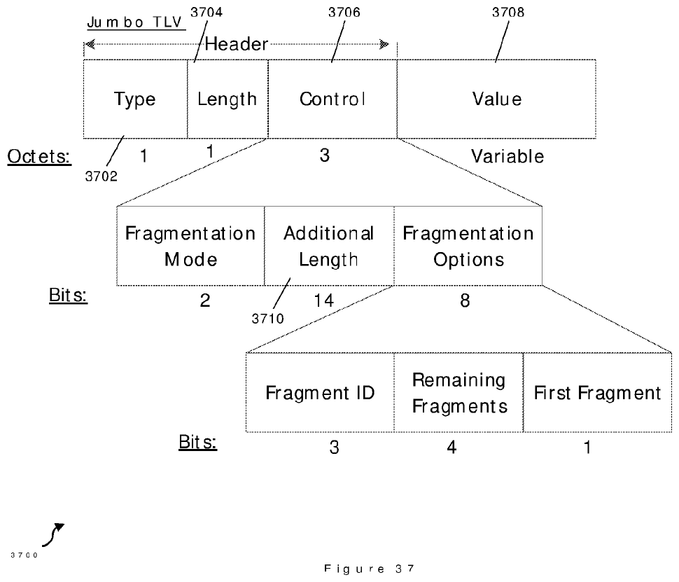

In an embodiment, a new variant of TLVs (type/length/value), called Jumbo TLV, may be used as unified container for information (regardless of size of data). Referring to Jumbo TLV 3700 of FIG. 37, meaning of Type field 3702, Length field 3704 and Value field 3708 are same as in baseline. The Type field 3702, Length field 3704, and Control field 3706 are considered part of the Header of the Jumbo TLV 3700. One or more values of the Type field 3702 may be configured to uniquely identify Jumbo elements (e.g., 0×Ed, 0×Ee identify two different Jumbo TLVs). Additional information required to parse the Jumbo TLV 3700 is carried in Control field 3706 that is present immediately prior to the Value field 3708. The meaning of the sub-fields of the Control field 3706 as well as the fragmentation scheme is same as the Jumbo elements as per previous embodiments. Further, 14 bits of Additional Length field 3710 can signal Data field length of up to 16,383 octets.

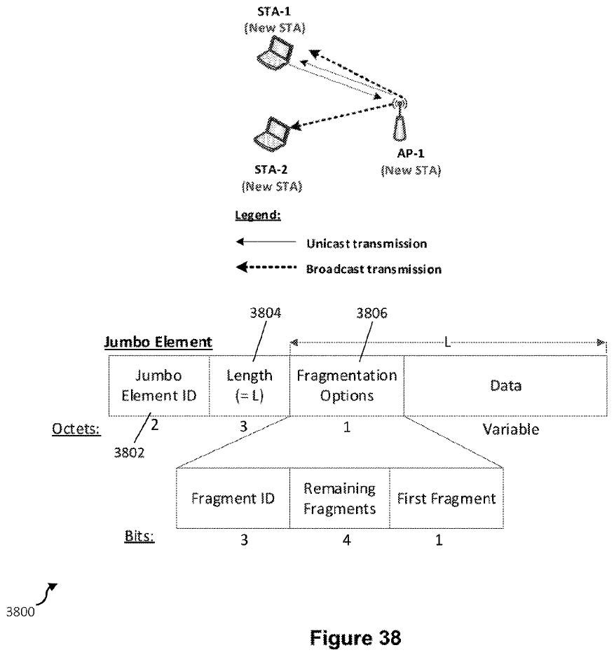

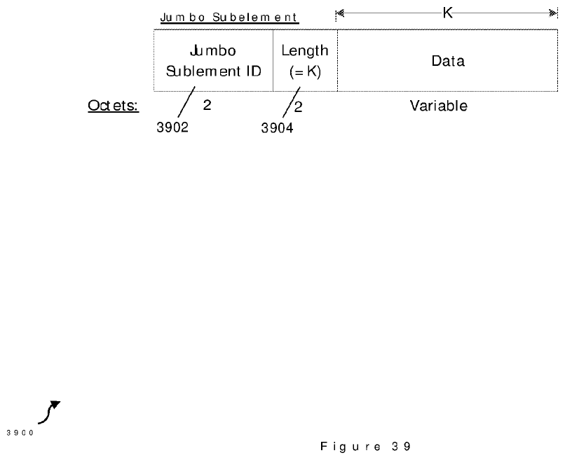

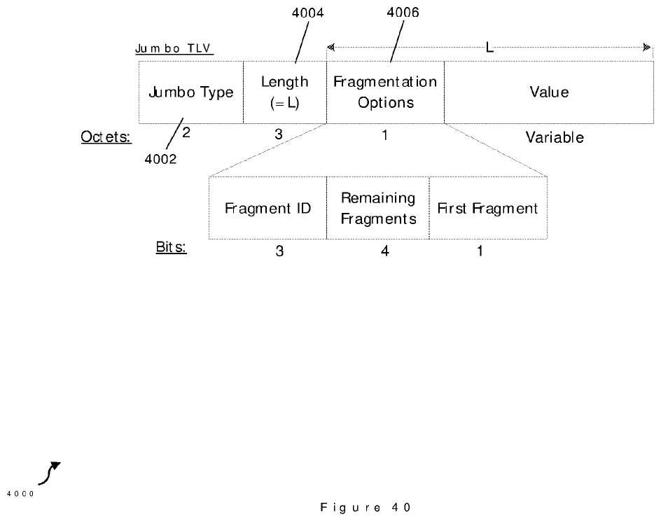

In an embodiment, when backward compatibility is not required e.g., when legacy STAs are never expected to parse the Jumbo elements/subelements/TLVs and legacy element/subelements/TLVs are never used together with Jumbo elements/subelements/TLVs in the same frame, a simplified format of Jumbo elements/subelements/TLVs can be used. Such a scenario where backward compatibility is not required may be possible for example when a new frequency band is available in future for 802.11, e.g., in the 7 GHz band and only New STAs are allowed to operate on the new frequency band, or it may also happen in existing frequency band (e.g., 5 GHz band) where the Basic Service Set (BSS) policy only allows newer generation STAs (e.g., New STAs) to join the BSS and legacy STAs are not allowed to join the BSS. Alternatively, the usage of the Jumbo elements/subelements/TLVs are restricted (e.g., as defined in the specification) to certain frame/packet types and these frames/packets only carry Jumbo element (e.g., do not carry legacy elements). Referring to Jumbo element 3800 of FIG. 38, Jumbo subelement 3900 of FIG. 39 and Jumbo TLV 4000 of FIG. 40, two octets of ID/Type field e.g., Jumbo Element ID field 3802, Jumbo Subelement ID field 3902 and Jumbo TLV field 4002 allows defining up to 65535 elements, subelements and TLVs respectively. Three octets of Length fields 3804 and 4004 respectively allows the Jumbo element 3800 and Jumbo TLV 4000 to carry up to 16777214 octets of data (e.g., assuming the supported maximum MPDU/Packet Size is large enough). Two octets of Length field 3904 allows the Jumbo subelement 3900 to carry up to 65535 octets of data. Meaning of Fragmentation Options fields 3806 and 4006 are same as per the Jumbo elements and TLVs of the previous embodiments (e.g., Jumbo Fragmentation) and are used to carry information related to Jumbo fragments of the Jumbo element 3800 and Jumbo TLV 4000 respectively, if the Jumbo element 3800 and Jumbo TLV 4000 are each split into two or more Jumbo fragments (e.g., due to the size exceeding the supported maximum MPDU Size).

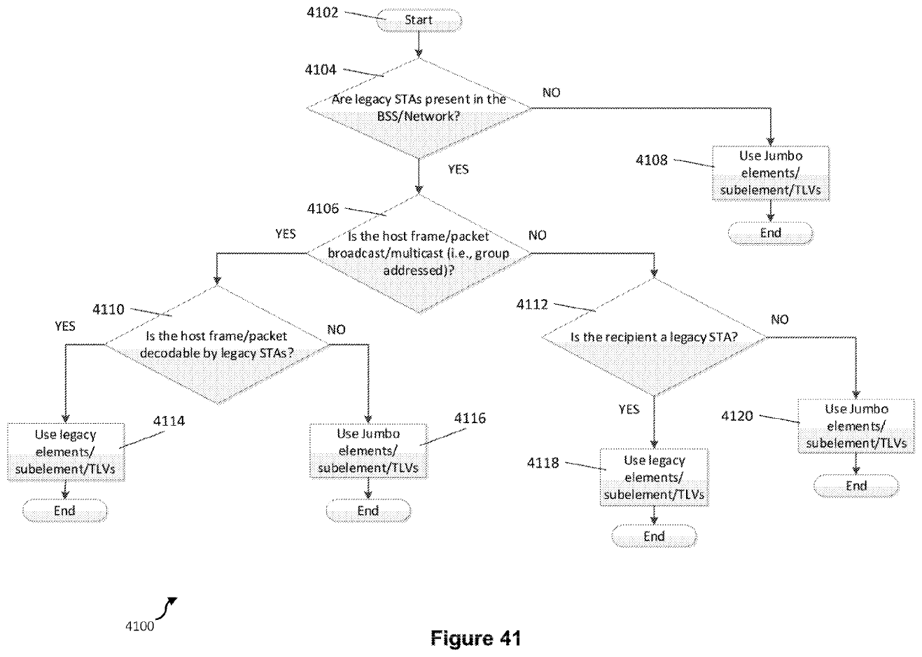

FIG. 41 shows a flowchart 4100 illustrating a transmission flow for a Jumbo Element variant according to an embodiment of the present disclosure. The process begins in step 4102. In step 4104 it is determined whether legacy STAs are present in a BSS or network. If it is not determined to the case, the process proceeds to step 4108 where Jumbo elements, subelements or TLVs are utilized, and the process ends. Otherwise, the process proceeds to step 4106 where it is determined if there is a host frame, packet, broadcast or multicast (e.g., whether a group of STAs are addressed). If it is determined to be the case, the process proceeds to step 4110 where it is determined if the host frame or packet is decodable by legacy STAs. If it is determined to be the case, the process proceeds to step 4114 where legacy elements, subelements or TLVs are utilized, and the process ends. Otherwise, the process proceeds to step 4116 where Jumbo elements, subelements or TLVs are used instead, and the process ends. On the other hand, if it is determined in step 4106 that there is not host frame, packet broadcast or multicast, the process proceeds to step 4112 where it is determined if the recipient is a legacy STA. If it is determined to be the case, the process proceeds to step 4118 where legacy elements, subelements or TLVs are utilized, and the process ends. Otherwise, the process proceeds to step 4120 where Jumbo elements, subelements or TLVs are used instead, and the process ends. In step 4110, when the host frame may carry either legacy elements or Jumbo elements, in order to avoid confusions for New STAs, a reserved value of the Element ID (e.g., a value between 245 & 254) may be used in the first Octet of the Jumbo Element ID field to identify the element as a Jumbo element while the second Octet of the Jumbo Element ID field identifies the Jumbo element subtype. Alternatively, the frames/packets may carry signaling (e.g., in the frame header) that indicate the type of the element carried in the frames/packet (e.g., one bit (e.g., called element type) set to 0 indicate that legacy elements are carried, the bit set to 1 indicate that Jumbo elements are carried).

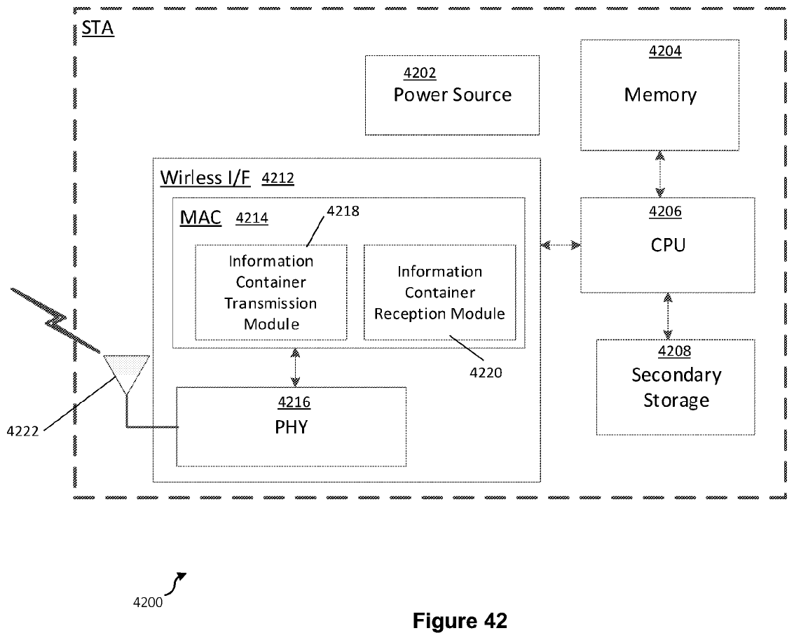

FIG. 42 shows an example configuration of a communication apparatus 4200. The communication apparatus 4200 is implemented as an AP or STA for utilizing an information container in accordance with various embodiments of the present disclosure. The communication apparatus 4200 comprises a power source 4202, a memory 4204, a central processing unit (CPU) 4206 comprising at least one processor, a secondary storage 4208 and a wireless I/F 4212. The memory 4204 may be a non-transitory computer-readable storage medium having stored therein data representing instructions executable by the at least one processor of the CPU 4206 to communicate with the wireless I/F 4212 to perform enhanced client discovery procedure according to various embodiments described in the present disclosure. The Wireless I/F 4212 comprises a MAC layer 4214 and a PHY layer 4216. The PHY layer 4216 connects with a radio transmitter (not shown), a radio receiver (not shown) and an antenna 4222 used for transmitting/receiving signals to/from other communication apparatuses (e.g., STAs/APs). The secondary storage 4208 may be configured to store AIDs of associated communication apparatus.

The MAC layer 4214 comprises an Information Container Transmission Module 4218. The Information Container Transmission Module 4218 may be configured to generate and transmit frames comprising an information container (e.g., Jumbo elements, Jumbo subelements, Jumbo TLVs, and other similar frames) according to various embodiments described above. The MAC layer 4214 further comprises Information Container Reception Module 4220 which is configured to receive and process frames comprising an information container (e.g., Jumbo elements, Jumbo subelements, Jumbo TLVs, and other similar frames) according to various embodiments described above.

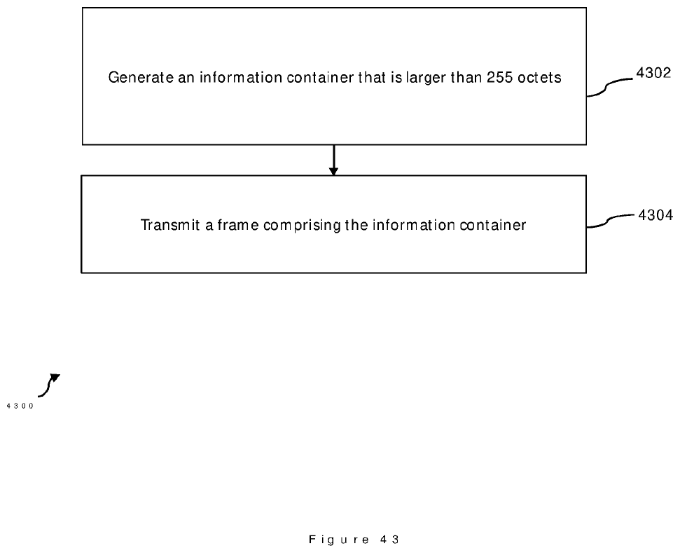

FIG. 43 shows a flow diagram 4300 illustrating a communication method according to various embodiments. At step 4302, an information container that is larger than 255 octets is generated. At step 4304, a frame comprising the information container is transmitted.

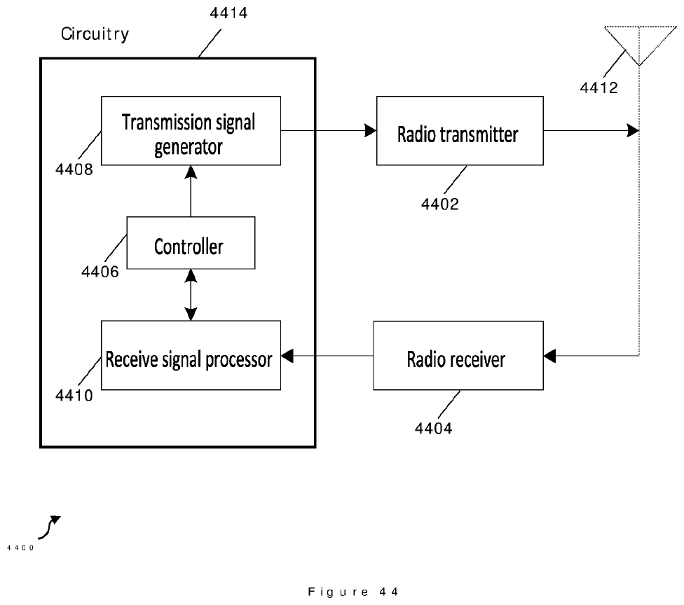

FIG. 44 shows a schematic, partially sectioned view of a communication apparatus 4400 that can be implemented for processing an information container in accordance with the various embodiments. The communication apparatus 4400 may be implemented as an STA or AP according to various embodiments.

Various functions and operations of the communication apparatus 4400 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 44, the communication apparatus 4400 may include circuitry 4414, at least one radio transmitter 4402, at least one radio receiver 4404 and multiple antennas 4412 (for the sake of simplicity, only one antenna is depicted in FIG. 44 for illustration purposes). The circuitry may include at least one controller 4406 for use in software and hardware aided execution of tasks it is designed to perform, including control of communications with one or more other devices in a wireless network. The at least one controller 4406 may control at least one transmission signal generator 4408 for generating frames to be sent through the at least one radio transmitter 4402 to one or more other STAs or APs and at least one receive signal processor 4410 for processing frames received through the at least one radio receiver 4404 from the one or more other STAs or APs. The at least one transmission signal generator 4408 and the at least one receive signal processor 4410 may be stand-alone modules of the communication apparatus 4400 that communicate with the at least one controller 4406 for the above-mentioned functions. Alternatively, the at least one transmission signal generator 4408 and the at least one receive signal processor 4410 may be included in the at least one controller 4406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3602, at least one radio receiver 4404, and at least one antenna 4412 may be controlled by the at least one controller 4406. Furthermore, while only one radio transmitter 4402 is shown, it will be appreciated that there can be more than one of such transmitters.

In various embodiments, when in operation, the at least one radio receiver 4404, together with the at least one receive signal processor 4410, forms a receiver of the communication apparatus 4400. The receiver of the communication apparatus 4400, when in operation, provides functions required for processing an information container. While only one radio receiver 4404 is shown, it will be appreciated that there can be more than one of such receivers.

The communication apparatus 4400, when in operation, provides functions required for generating and transmitting an information container. For example, the circuitry 4414 may, in operation, generate an information container that is larger than 255 octets. The transmitter 4402 may, in operation, transmit a frame comprising the information container.

The information container may be split into a plurality of fragments, the information container comprising information relating to the plurality of fragments. The receiver 4404 may, in operation, receive a retransmission request frame soliciting retransmission of one or more fragments of the plurality of fragments; and the transmitter 4402 may be further configured to transmit the requested one or more fragments.

The information container may indicate a size of the information container or a size of a fragment of the information container. The information container may be one of an element, a subelement or a TLV (type/length/value).

The information container may comprise information relating to a mode of fragmentation of the information container. The circuitry 4414 may be further configured to determine the mode of fragmentation based on a type of the frame. The circuitry 4414 may be further configured to determine the mode of fragmentation based on a type of communication apparatus to which the frame is addressed.

The communication apparatus 4400, when in operation, provides functions required for receiving and processing an information container. For example, the receiver 4404 may, in operation, receive a frame comprising an information container, the information container comprising data that is larger than 255 octets. The circuitry 4414 may, in operation, extract the data from the information container.

The information container may be split into a plurality of fragments, the information container comprising information relating to the plurality of fragments. The transmitter 4402 may, in operation, transmit a retransmission request frame soliciting retransmission of one or more fragments of the plurality of fragments; and wherein the receiver 4404 may be further configured to receive the requested one or more fragments.

The information container may indicate a size of the information container or a size of a fragment of the information container. The information container may be one of an element, a subelement or a TLV (type/length/value).

The information container may comprise information relating to a mode of fragmentation of the information container. The circuitry 4414 may be further configured to extract the data from the information container based on the mode of fragmentation.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device, head mounted display (HMD), smart glasses), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for processing an information container.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A communication apparatus comprising:
circuitry, which in operation, generates an information container that is larger than 255 octets; and
a transmitter, which in operation, transmits a frame comprising the information container.

2. The communication apparatus of claim 1, wherein the information container is split into a plurality of fragments, the information container comprising information relating to the plurality of fragments.

3. The communication apparatus of claim 2, further comprising a receiver which, in operation, receives a retransmission request frame soliciting retransmission of one or more fragments of the plurality of fragments; and wherein the transmitter is further configured to transmit the requested one or more fragments.

4. The communication apparatus of claim 1, wherein the information container comprises information relating to a mode of fragmentation of the information container.

5. The communication apparatus of claim 4, wherein the circuitry is further configured to determine the mode of fragmentation based on a type of the frame.

6. The communication apparatus of claim 4, wherein the circuitry is further configured to determine the mode of fragmentation based on a type of communication apparatus to which the frame is addressed.

7. The communication apparatus of claim 1, wherein the information container indicates a size of the information container or a size of a fragment of the information container.

8. The communication apparatus of claim 1, wherein the information container is one of an element, a subelement or a TLV (type/length/value).

9. A communication apparatus comprising:
a receiver, which in operation, receives a frame comprising an information container, the information container comprising data that is larger than 255 octets; and
circuitry, which in operation, extracts the data from the information container.

10. The communication apparatus of claim 9, wherein the information container is split into a plurality of fragments, the information container comprising information relating to the plurality of fragments.

11. The communication apparatus of claim 10, further comprising a transmitter which, in operation, transmits a retransmission request frame soliciting retransmission of one or more fragments of the plurality of fragments; and wherein the receiver is further configured to receive the requested one or more fragments.

12. The communication apparatus of claim 9, wherein the information container comprises information relating to a mode of fragmentation of the information container.

13. The communication apparatus of claim 12, wherein the circuitry is further configured to extract the data from the information container based on the mode of fragmentation.

14. The communication apparatus of claim 9, wherein the information container indicates a size of the information container or a size of a fragment of the information container.

15. The communication apparatus of claim 9, wherein the information container is one of an element, a subelement or a TLV (type/length/value).

16. A communication method comprising:
generating an information container that is larger than 255 octets; and
transmitting a frame comprising the information container.
